(19) United States
(12) Patent Application Publication
(10) Pub. No.: US 2026/0289990 A1
(43) Pub. Date: Sep. 24, 2026

(54) SYSTEM

(71) Applicant: SoftBank Group Corp., Tokyo (JP)

(72) Inventor: Takahiro MURAKAMI, Tokyo (JP)

(73) Assignee: SoftBank Group Corp., Tokyo (JP)

(21) Appl. No.: 19/567,006

(22) Filed: Mar. 14, 2026

(30) Foreign Application Priority Data
Mar. 19, 2025 (JP) 2025-045103

(51) Int. Cl. G06V 10/82; G06F 40/284; G06F 40/295; G06F 40/30; G06T 7/20; G06V 10/25; G10L 13/027

(52) U.S. Cl. CPC G06V 10/82; G06F 40/284; G06F 40/295; G06F 40/30; G06T 7/20; G06V 10/25; G06T 2207/20084; G10L 13/027

(57) ABSTRACT

A system includes a processor that is configured to control an imaging device to capture a surrounding situation and generate image data, transmit the image data to an analysis device via a data transmission device, and generate a prompt for instructing a generative AI model to analyze the image data using the generative AI model, extract features in an image, and generate an analysis result, and provide the prompt as an input to the generative AI model.

### CROSS-REFERENCE TO RELATED APPLICATION

This application is based on and claims priority under 35 USC 119 from Japanese Patent Application No. 2025-045103 filed on Mar. 19, 2025, the disclosure of which is incorporated by reference herein.

### BACKGROUND

### Technical Field

The present disclosure relates to a system.

### Related Art

Japanese Patent Application Laid-Open (JP-A) No. 2022-180282 discloses a persona chatbot control method executed by at least one processor. The method includes steps of: receiving a user utterance, adding the user utterance to a prompt including a description of a chatbot character and an associated instruction sentence, encoding the prompt, and inputting the encoded prompt to a language model to generate a chatbot utterance responding to the user utterance.

Conventional image analysis systems that utilize artificial intelligence typically require manually designed analysis logic, predefined recognition pipelines, or static models that are directly applied to image data. As a result, such systems have limited flexibility in adapting to diverse analysis objectives, such as recognizing different types of objects, characters, or semantic relationships according to a specific use case. Furthermore, conventional systems often do not provide an integrated mechanism in which a processor dynamically generates prompts tailored to a generative AI model so that the model can perform context-aware analysis of image data. In addition, when analysis results are intended to be presented to a user, known systems do not always enable seamless, real-time conversion of such results into voice output in a unified architecture controlled by a single processor. Therefore, there is a need for a system that can flexibly and dynamically control an imaging device, generate and transmit image data, create prompts adapted to a generative AI model for extracting features and understanding meanings in the image, and, when necessary, output corresponding voice information to the user in real time under integrated control by a processor.

### SUMMARY

In order to solve the above-described problem, according to one embodiment, there is provided a system comprising a processor, wherein the processor is configured to control an imaging device to capture a surrounding situation and generate image data, and to transmit the image data to an analysis device via a data transmission device. The processor is further configured to generate a prompt for instructing a generative AI model to analyze the image data using the generative AI model, extract features in an image, and generate an analysis result, and to provide the prompt as an input to the generative AI model. In one aspect, the processor is configured to generate a prompt for instructing the generative AI model to perform recognition of objects and characters in the image and to understand meanings thereof, and to perform an analysis by using the prompt. In another aspect, the processor is configured to control a voice conversion device so as to output, in real time, voice data generated based on the analysis result, and to notify a user through a voice output device. By these means, the system enables dynamic, prompt-based control of the generative AI model for flexible image analysis and integrated, real-time notification of analysis results to the user.

The term “system” refers to an arrangement including at least one processor and one or more devices such as an imaging device, a data transmission device, an analysis device, a voice conversion device, and a voice output device, which cooperate to perform image analysis using a generative AI model and provide results to a user.

The term “processor” refers to any hardware and/or software processing unit, such as a CPU, GPU, microcontroller, or dedicated logic circuitry, that executes instructions to control devices, generate prompts, transmit data, and manage analysis and output operations as described herein.

The term “imaging device” refers to a device configured to capture a surrounding situation and generate corresponding image data, such as a digital camera, video camera, or any image sensor integrated into smart glasses, mobile terminals, or other equipment.

The term “surrounding situation” refers to a physical environment in the vicinity of the imaging device, including objects, persons, text, and other visual elements that can be captured as image data by the imaging device.

The term “image data” refers to digital data representing an image or a sequence of images captured by the imaging device, including still images, video frames, or any encoded or compressed representation thereof.

The term “data transmission device” refers to a communication interface or module configured to transmit data, including image data and prompts, between the processor and an external or internal analysis device, such as a wired or wireless network interface.

The term “analysis device” refers to a device or system, which may be local or remote, that executes or provides access to a generative AI model to analyze image data and generate analysis results according to prompts received from the processor.

The term “generative AI model” refers to a machine learning model, such as a large language model or multimodal model, capable of generating outputs including analysis results, textual descriptions, or structured data in response to prompts and, in some cases, input images.

The term “prompt” refers to information generated by the processor and provided as an input command or instruction to the generative AI model, the information specifying how the generative AI model is to analyze image data, extract features, recognize objects or characters, or generate analysis results.

The term “features in an image” refers to elements or characteristics contained within image data, including but not limited to objects, shapes, edges, text, colors, spatial relationships, and semantic attributes that can be extracted or identified by the generative AI model.

The term “analysis result” refers to data generated by the generative AI model in response to a prompt and image data, including descriptions, classifications, recognized objects or characters, semantic interpretations, or any structured or unstructured information representing the outcome of the analysis.

The term “objects” refers to physical entities depicted in image data, such as vehicles, buildings, furniture, animals, or human bodies, which can be detected, recognized, or classified by the generative AI model.

The term “characters” refers to textual elements contained in image data, including letters, numbers, symbols, or ideograms appearing on signs, screens, documents, or other surfaces that can be recognized by the generative AI model.

The term “meanings thereof” refers to semantic information, contextual interpretation, or understood content associated with recognized objects or characters, including their roles, functions, relationships, or implications in the surrounding situation.

The term “voice conversion device” refers to a device or module configured to convert text or analysis results into audio or voice data, such as a text-to-speech engine or any hardware and/or software capable of generating synthetic speech signals.

The term “voice data” refers to digital audio data representing spoken information, including synthesized speech generated based on analysis results or prompts, which can be output to a user via a voice output device.

The term “voice output device” refers to a device configured to output voice data to a user, such as an earphone, headphone, speaker, bone-conduction transducer, or any other audio reproduction device.

The term “user” refers to a person who uses or wears a terminal or device incorporating the system, receives notification of analysis results, and may rely on the system for understanding or navigating the surrounding situation.

The term “real time” refers to processing and output that occur with a delay short enough that the user can perceive the analysis results or voice output as substantially immediate with respect to the captured surrounding situation.

### BRIEF DESCRIPTION OF THE DRAWINGS

Exemplary embodiments of the present disclosure will be described in detail based on the following figures, wherein:

FIG. 1 is a schematic diagram illustrating an example of a configuration of a data processing system according to a first exemplary embodiment;

FIG. 2 is a schematic diagram illustrating an example of relevant functions of a data processing device and a smart device according to the first exemplary embodiment;

FIG. 3 is a schematic diagram illustrating an example of a configuration of a data processing system according to a second exemplary embodiment;

FIG. 4 is a schematic diagram illustrating an example of relevant functions of a data processing device and smart glasses according to the second exemplary embodiment;

FIG. 5 is a schematic diagram illustrating an example of a configuration of a data processing system according to a third exemplary embodiment;

FIG. 6 is a schematic diagram illustrating an example of relevant functions of a data processing device and a headset-type terminal according to the third exemplary embodiment;

FIG. 7 is a schematic diagram illustrating an example of a configuration of a data processing system according to a fourth exemplary embodiment;

FIG. 8 is a schematic diagram illustrating an example of relevant functions of a data processing device and a robot according to the fourth exemplary embodiment;

FIG. 9 illustrates an emotion map mapping plural emotions;

FIG. 10 illustrates an emotion map mapping plural emotions;

FIG. 11 is a sequence diagram showing the flow of data processing system processing in Example 1;

FIG. 12 is a sequence diagram showing the flow of data processing system processing in Application Example 1;

FIG. 13 is a sequence diagram showing the flow of data processing system processing in Example 2; and

FIG. 14 is a sequence diagram showing the flow of data processing system processing in Application Example 2.

### DETAILED DESCRIPTION

Description follows regarding an example of exemplary embodiments of a system according to technology disclosed herein, with reference to the appended drawings.

First, explanation follows regarding terminology employed in the following description.

In the following exemplary embodiments, a reference-numeral-appended processor (hereinafter simply referred to as “processor”) may be implemented by a single computation unit, and may be implemented by a combination of plural computation units. The processor may be implemented by a single type of computation unit, or may be implemented by a combination of plural types of computation units. Examples of computation unit include a central processing unit (CPU), a graphics processing unit (GPU), a general-purpose computing on graphics processing units (GPGPU), an accelerated processing unit (APU), and the like.

In the following exemplary embodiments, random access memory (RAM) appended with a reference numeral is memory temporarily stored with information, and is employed as working memory by a processor.

In the following exemplary embodiments, reference-numeral-appended storage is a single or plural non-volatile storage devices for storing various programs and various parameters and the like. Examples of non-volatile storage devices include flash memory (such as a solid state drive (SSD)), a magnetic disk (for example, a hard disk), magnetic tape, and the like.

In the following exemplary embodiments, a reference-numeral-appended communication interface (I/F) is an interface including a communication processor and an antenna or the like. The communication I/F has the role of communicating between plural computers. An example of a communication standard applied for the communication I/F is a wireless communication standard, such as a Fifth Generation Mobile Communication System (5G), Wi-Fi (registered trademark), Bluetooth (registered trademark), and the like.

In the following exemplary embodiments “A and/or B” has the same definition as “at least one out of A or B”. Namely, “A and/or B” may mean A alone, may mean B alone, or may mean a combination of A and B. Moreover, similar logic to “A and/or B” is applied when “and/or” is employed to link three or more items in the present specification.

### First Exemplary Embodiment

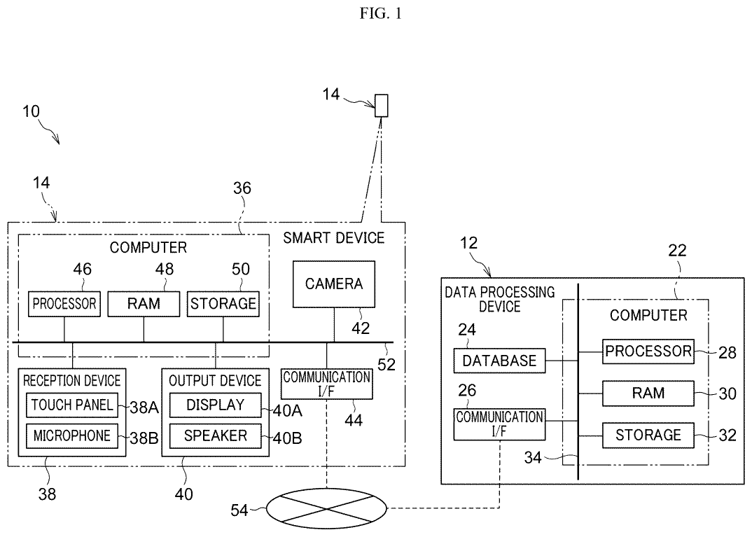

FIG. 1 illustrates an example of a configuration of a data processing system 10 according to a first exemplary embodiment.

As illustrated in FIG. 1, the data processing system 10 includes a data processing device 12 and a smart device 14. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart device 14 includes a computer 36, a reception device 38, an output device 40, a camera 42, and a communication I/F 44. The computer 36 includes a processor 46, RAM 48, and storage 50. The processor 46, the RAM 48, and the storage 50 are connected to a bus 52. The reception device 38, the output device 40, the camera 42, and the communication I/F 44 are also connected to the bus 52.

The reception device 38 includes a touch panel 38A, a microphone 38B, and the like for receiving user input. The touch panel 38A receives user input from contact of a pointer (for example, a pen, a finger, or the like) by detecting contact of the pointer. The microphone 38B receives spoken user input by detecting speech of the user. A control unit 46A in the processor 46 transmits data representing the user input received by the touch panel 38A and the microphone 38B to the data processing device 12. A specific processing unit 290 in the data processing device 12 acquires the data indicating the user input.

The output device 40 includes a display 40A, a speaker 40B, and the like for presenting data to a user 20 by outputting the data in an expression format perceivable by the user 20 (for example, audio and/or text). The display 40A displays visual information such as text, images, or the like under instruction from the processor 46. The speaker 40B outputs audio under instruction from the processor 46. The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like.

The communication I/F 44 is connected to the network 54. The communication I/F 44 and the communication I/F 26 perform the role of exchanging various information between the processor 46 and the processor 28 over the network 54.

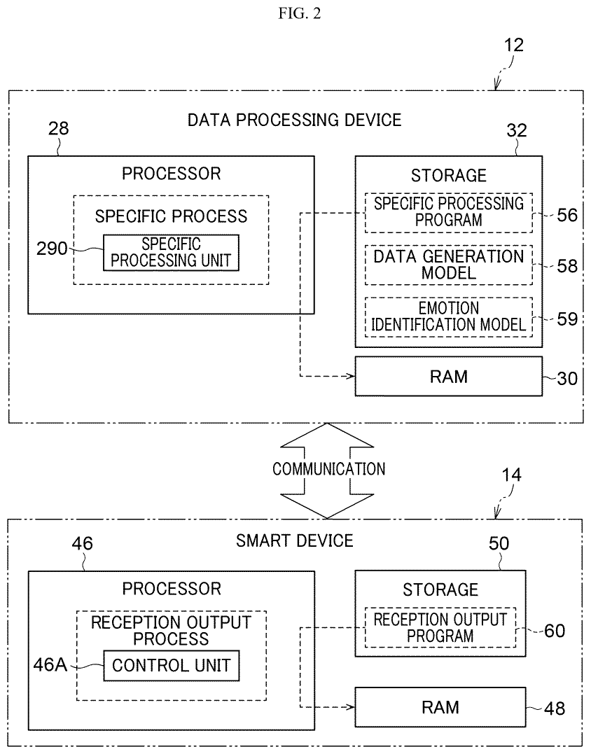

FIG. 2 illustrates an example of relevant functions of the data processing device 12 and the smart device 14.

As illustrated in FIG. 2, specific processing is performed by the processor 28 in the data processing device 12. A specific processing program 56 is stored in the storage 32. The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

A data generation model 58 and an emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart device 14. A reception and output program 60 is stored in the storage 50. The reception and output program 60 is employed by the data processing system 10 in combination with the specific processing program 56. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48. Note that a configuration may be adopted in which a similar data generation model and emotion identification model to the data generation model 58 and the emotion identification model 59 are included in the smart device 14, and these models are used to perform similar processing to the specific processing unit 290. The reception and output program is implemented by the processor 46 operating as the control unit 46A according to the reception and output program 60 executed in the RAM 48.

Note that devices other than the data processing device 12 may include the data generation model 58. For example, a server device (for example, a generation server) may include the data generation model 58. In such cases, the data processing device 12 performs communication with the server device including the data generation model 58 to obtain a processing result (prediction result or the like) obtained using the data generation model 58. The data processing device 12 may be a server device, and may be a terminal device owned by the user (for example, a mobile phone, a robot, a home electrical appliance, or the like). Next, description follows regarding an example of processing by the data processing system 10 according to the first exemplary embodiment.

### Example 1

Description follows regarding a flow of the specific processing in an Example 1. The units of the system described below are implemented by the data processing device 12 and the smart device 14. The data processing device 12 is called a “server” and the smart device 14 is called a “terminal”.

In conventional computer-implemented assistance systems for visually impaired users, scene understanding from image data is typically performed by narrowly specialized recognition modules, such as fixed-function object detectors or rule-based classifiers. These approaches suffer from several technical limitations in the context of real-time mobility assistance. First, the processing pipeline is fragmented: image acquisition, object detection, text recognition, and alert generation are often implemented as separate components with rigid interfaces, which introduce latency and reduce robustness when the environmental context changes. Second, conventional systems generally lack a mechanism to flexibly condition the analysis on the user's current mobility context (for example, “approaching a crosswalk” versus “walking in a narrow corridor”), which results in the generation of either excessive, irrelevant information or insufficient, safety-critical information. Third, many existing systems are not optimized for efficient use of modern generative AI models; they either treat generative models as generic captioning engines without structured control, or they rely on static prompts that do not systematically translate safety-relevant semantics into machine-usable representations for downstream processing.

From a computer-technology perspective, these limitations manifest as suboptimal utilization of processing resources in distributed client-server architectures, inefficient formatting and conditioning of multimodal inputs to generative AI models, and inadequate transformation of free-form natural language outputs into structured data suitable for low-latency speech synthesis on resource-constrained terminals. As a result, there is increased computational overhead on the server, unnecessary network traffic, and delayed or ambiguous guidance at the terminal, which directly impact the quality and reliability of real-time assistive behavior. Accordingly, there is a need for an improved computer-implemented system and method that (i) coordinates image acquisition and server-side analysis in a unified processing flow, (ii) programmatically generates context-specific prompt sentences to drive a generative AI model toward safety-critical visual semantics, and (iii) converts the model's natural language output into structured data that can be efficiently consumed by a terminal-side speech synthesis pipeline. Such a system should reduce end-to-end latency, improve the relevance and clarity of the generated guidance, and more effectively leverage the capabilities of generative AI models for real-time mobility assistance, thereby constituting a concrete improvement in computer-based image analysis and human-machine interaction.

The specific processing by the specific processing unit 290 of the data processing device 12 in Example 1 is realized by the following means.

The present invention provides a server comprising a processor configured to receive, via a communication control device, image data acquired in a time series by an image acquisition device of a terminal, to convert the image data into numerical data using preprocessing software and to normalize the numerical data into an input format adapted to a generative machine learning model, to generate a prompt sentence according to a mobility-assistance context for a visually impaired user so as to specify an analysis target and an output format, to supply the generative machine learning model with a multimodal input in which the prompt sentence is combined with the normalized numerical data, to cause the generative machine learning model to extract, based on the prompt sentence, safety-related features including signal indicators, passable regions, obstacles, and display information from the image data and to generate a natural language sentence representing an analysis result related to safety of walking, and to extract, from the natural language sentence, information elements indicating a signal state, a permission or prohibition of passage, and cautionary information and to generate structured data including the information elements and to transmit the structured data back to the terminal. This enables a coordinated, computer-implemented pipeline in which server-side processing dynamically conditions a generative AI model by context-specific prompt sentences, transforms high-dimensional visual input into compact, safety-focused structured data, reduces latency and bandwidth requirements in a distributed architecture, and improves the technical performance and reliability of real-time guidance generation for visually impaired users.

The term “processor” refers to a hardware or virtual computation unit, such as a central processing unit or graphics processing unit, configured to execute instructions of a computer program to perform data processing, control, and communication operations described in this specification.

The term “system” refers to a combination of one or more terminals, one or more servers, and associated devices and software modules that collectively implement the functions described in the claims and specification.

The term “image acquisition device” refers to a hardware component or set of components, such as a camera or imaging sensor, configured to capture a surrounding situation as image data with a predefined spatial resolution and temporal resolution.

The term “image data” refers to digital data representing one or more images or frames captured by the image acquisition device, including still images or video frames encoded in any suitable format.

The term “communication control device” refers to a hardware and software combination, such as a wireless or wired communication interface and its control program, configured to transmit and receive data between a terminal and a server over a communication network.

The term “analysis information processing apparatus” refers to a computing apparatus, typically provided on a server side, that executes software modules for preprocessing image data, interfacing with a generative machine learning model, and generating analysis results and structured data.

The term “preprocessing software” refers to one or more software modules configured to convert image data into numerical data, including decoding, resizing, normalization, format conversion, and any other operation necessary to prepare the data for input to a generative machine learning model.

The term “numerical data” refers to data represented in a numerical form, such as tensors, matrices, or arrays of numerical values, suitable for input to a machine learning model.

The term “input format adapted to a generative machine learning model” refers to a data representation, including dimensionality, normalization, and encoding structure, that is compatible with and expected by a particular generative machine learning model for accurate inference.

The term “generative machine learning model” refers to a parameterized computational model, such as a neural network, configured to generate output data, including natural language text, based on input data, and that may include a vision encoder, a language model, or a multimodal model trained with image and text data.

The term “prompt sentence” refers to a natural language or machine-readable text string provided as part of the input to the generative machine learning model, the content of which conditions or constrains the analysis target, output format, or semantic focus of the model's generation.

The term “multimodal input” refers to a combined representation comprising at least image-based numerical data and a prompt sentence, or otherwise data from different modalities, provided together to a generative machine learning model for joint processing.

The term “safety-related features” refers to features in image data that are relevant to the safety of a user's movement, including but not limited to signal indicators, passable regions, obstacles, display information, and other environmental elements affecting safe walking.

The term “signal indicators” refers to visual elements in the image data that convey traffic or movement signals, including but not limited to traffic lights, pedestrian signals, and other devices that visually indicate a permission or prohibition of movement.

The term “passable regions” refers to regions in the image data that are suitable for safe movement by a user, such as sidewalks, crosswalks, and unobstructed paths, as determined by image analysis.

The term “obstacles” refers to objects or conditions in the image data that may impede or endanger a user's movement, such as vehicles, bicycles, pedestrians, steps, dropped objects, or other hazards on or near a walking path.

The term “display information” refers to visual information presented on signs, boards, or other display media in the image data, including text, icons, arrows, warnings, or other symbols relevant to navigation or safety.

The term “natural language sentence” refers to a sequence of words or tokens generated in a human language by the generative machine learning model to describe an analysis result, such as an evaluation of safety, signal status, or recommended action.

The term “analysis result related to safety of walking” refers to an output of the computation performed by the server, expressed in natural language or structured data, that evaluates conditions of the environment and indicates whether and how a user can safely move.

The term “information elements” refers to distinct units of information extracted from a natural language sentence, such as a signal state, a permission or prohibition of passage, and cautionary information, which are suitable for representation in a structured data format.

The term “signal state” refers to a condition of a signal indicator, such as red, green, or other states, indicating whether movement is permitted, prohibited, or subject to caution.

The term “permission or prohibition of passage” refers to an indication, derived from the analysis, of whether a user is allowed, not allowed, or advised against moving through a particular region at a particular time.

The term “cautionary information” refers to additional instructions or warnings, derived from the analysis, that advise a user to take care, slow down, stop, or otherwise modify movement in response to environmental conditions.

The term “structured data” refers to data organized in a defined format, such as a record, table, or key-value set, in which fields correspond to specific information elements including signal state, permission or prohibition of passage, and cautionary information.

The term “terminal” refers to a user-side device, which may include the image acquisition device, one or more processors, a memory, communication interfaces, and audio output components, configured to interact with the server and provide guidance to a user.

The term “text for speech synthesis” refers to a text string derived from structured data and intended to be input to a text-to-speech engine for generating corresponding audio data.

The term “sound signal generation device” refers to a hardware and software combination configured to convert text for speech synthesis into audio data, such as a text-to-speech engine executing on a processor.

The term “audio data” refers to digital data representing sound, such as a waveform or encoded audio stream, suitable for playback by an acoustic output device.

The term “acoustic output device” refers to hardware configured to output sound to a user, such as a speaker, earphone, or bone-conduction transducer.

The term “real time” refers to processing and output of information within a time interval sufficiently short that a user can use the information for immediate decision making during movement, such that delay does not materially reduce the usefulness of the guidance.

The term “mobility-assistance context” refers to information about a user's current movement situation, such as approaching an intersection, walking along a sidewalk, or navigating around obstacles, used to determine the content of prompt sentences and the focus of analysis.

The term “ambient sound level” refers to a measure of environmental noise, obtained by a sensor or estimated, used to adjust volume or speaking rate of audio output.

The term “movement speed of the user” refers to an estimate or measurement of how fast a user is moving, derived from sensors or system state, used to tailor timing and content of guidance messages.

In one embodiment, a server, a terminal, and a user cooperate to implement a mobility assistance system that uses a generative AI model controlled by context-specific prompt sentences. The system is configured to capture images of a surrounding real-world environment, process the images with a multimodal generative model on the server, and provide low-latency, safety-focused audio guidance to the user through the terminal.

### A. Hardware and Software Configuration

### A.1 Terminal Configuration

The terminal is implemented as a wearable device, for example smart glasses, including at least an image acquisition device, a processor, a memory, a communication control device, and an acoustic output device.

The terminal uses an image acquisition device that is realized by an imaging sensor such as a CMOS image sensor and an optical lens assembly. The terminal processor controls the image acquisition device via a platform-specific camera framework, such as an Android Camera2 API or an iOS AVFoundation API. The terminal processor executes application software stored in the memory to set imaging parameters, such as resolution (for example, 1920×1080 pixels), frame rate (for example, 30 frames per second), exposure, and focus.

The terminal uses a communication control device, such as a wireless communication module supporting cellular communication or wireless local area network communication, together with a communication stack implementing a transport protocol such as TCP/IP and an application protocol such as HTTPS. The terminal processor executes network client software, for example a REST client library, to transmit image data to the server and to receive structured analysis data from the server.

The terminal includes an acoustic output device such as earphones, a bone-conduction transducer, or a small speaker embedded in the frame. The terminal processor controls the acoustic output device via an audio subsystem, such as an Android AudioTrack API or an iOS audio framework, and cooperates with a text-to-speech engine, such as an embedded TTS engine, to generate audio data from text.

### A.2 Server Configuration

The server is implemented as a computing apparatus including at least a general-purpose central processing unit, one or more graphics processing units, a main memory, a storage device, and a network interface device. The server executes an operating system such as a general-purpose server operating system, and application software including a web server component, a preprocessing component, and a generative AI model component.

The server hosts an analysis information processing apparatus realized as a set of software modules executing on the server processor. The server processor runs a web framework, such as a Python-based framework or a JavaScript-based framework, to receive requests that include image data from the terminal. The server processor uses an image-processing library, for example OpenCV or Pillow, to decode compressed image data (for example, JPEG data) into numerical data such as floating-point tensors. The server processor then uses a machine learning framework, such as PyTorch or TensorFlow, to process the numerical data through a generative AI model.

### B. Generative AI Model Configuration

The server uses a generative AI model that integrates a vision encoder and a language decoder in a multimodal architecture. In one embodiment, the vision encoder comprises a convolutional neural network or a vision transformer trained on large-scale image datasets. The language decoder comprises a transformer-based autoregressive language model that outputs natural language tokens.

The generative AI model uses parameters (weights) learned from training data including pairs of images and text descriptions. The vision encoder transforms normalized image tensors into visual feature vectors, for example high-dimensional embeddings for image regions or global image descriptors. The language decoder receives the visual feature vectors together with a token sequence representing a prompt sentence. The transformer's self-attention and cross-attention layers compute joint representations of image features and prompt tokens, enabling conditional text generation.

During training, the server uses a loss function such as cross-entropy loss between predicted token distributions and ground-truth tokens, and updates model parameters by gradient-based optimization methods such as stochastic gradient descent or Adam. The server may apply data augmentation operations, such as random cropping, horizontal flipping, and color jittering, to improve robustness of visual features. The server may fine-tune the model on domain-specific data capturing traffic signals, crosswalks, obstacles, and signage in urban environments to improve safety-related recognition performance.

### C. Program Structure and Data Processing on the Server

The server processor implements the analysis information processing apparatus as modular software components.

The server uses a reception module to accept network requests containing image data and metadata from the terminal. The server uses a decoding module to transform compressed image bytes into numerical arrays. The server uses a normalization module to rescale pixel values, reorder channels, and resize the arrays to an input size expected by the vision encoder, for example 224×224 or 384×384 pixels.

The server uses a prompt generation module to generate a prompt sentence dynamically according to a mobility-assistance context. The server determines the mobility-assistance context from factors such as location information, recent analysis results, and an application mode. For example, when the user is geographically near an intersection, the server may select a prompt designed for traffic signal recognition and crosswalk analysis.

The server generates prompt sentences in natural language that restrict the analysis target to safety-related items and constrain the output format to short, concise statements. Example prompt sentences include:
“You are assisting a visually impaired user who is approaching a crosswalk. Examine the image and answer briefly: what is the color of the pedestrian traffic signal, and is it safe to cross now?”“You are a navigation assistant for a blind person. Look at the image and describe only safety-relevant information in one or two short sentences: traffic lights, crosswalks, obstacles on the ground, approaching vehicles, bicycles, and steps.”
“Read any road sign or warning sign visible in the image and summarize its meaning in a single simple sentence for a visually impaired pedestrian.”
“Analyze the image captured by the camera, recognize the color of the traffic signal, and generate one sentence that can be spoken aloud to notify the user about the signal status and whether to cross or wait.”

The server concatenates the prompt sentence with special tokens defining the beginning and end of the prompt and inserts a token indicating the presence of image features. The server converts the prompt sentence into token IDs by using a tokenizer associated with the language model.

The server uses a multimodal fusion module to combine the normalized image tensors with the tokenized prompt sentence. The server passes the image tensors to the vision encoder to obtain visual embeddings, and passes the token IDs to an embedding layer of the language model. The server uses a cross-attention mechanism linking visual embeddings to language tokens, forming a multimodal input structure.

The server uses a generation module to run the language decoder in inference mode, sequentially generating tokens that form a natural language sentence. The server applies constraints such as a maximum length, a decoding strategy (for example, greedy decoding or beam search), and a temperature parameter to control randomness.

The server uses a semantic extraction module to parse the generated natural language sentence. The semantic extraction module applies rule-based patterns and/or lightweight classifiers to detect a signal state (such as “red”, “green”, or “don't walk”), a permission or prohibition of passage (such as “safe to cross” or “not safe to cross”), and cautionary information (such as “car approaching from your left” or “obstacle two meters ahead”).

The server organizes these information elements into structured data, for example a record with fields for signal state, safety evaluation, and narration text. By converting free-form text into structured data, the server enables the terminal to apply consistent policies for speech generation and user notification while minimizing the amount of data transmitted.

### D. Program Structure and Data Processing on the Terminal

The terminal processor executes an application program that coordinates image capture, communication, and audio output. The terminal application uses a buffer in the memory to store recent image frames, which improves robustness against temporary network latency. The terminal attaches metadata such as timestamps and approximate position when sending image data, which allows the server to select appropriate prompt sentences and to discard stale frames.

The terminal receives structured data from the server and parses it using a JSON or similar parser. The terminal extracts narration text and control parameters such as signal state and safety evaluation. The terminal uses a policy module to determine content, length, and output frequency of audio notifications. For example, when the signal state is red, the terminal refrains from sending repeated long messages and instead outputs a concise message at a lower frequency to reduce cognitive load on the user, while still ensuring that safety-critical changes are announced immediately.

The terminal uses a speech synthesis module that wraps a text-to-speech engine. The terminal configures parameters such as language, voice type, speaking rate, and volume. The terminal adjusts the volume and speaking rate based on an estimated movement speed of the user and an ambient sound level, measured by a microphone or derived from system settings. By dynamically adjusting audio characteristics, the terminal improves intelligibility and user comfort in different acoustic environments.

The terminal controls the acoustic output device through audio APIs and streams generated audio data in a way that minimizes latency, so that the user receives guidance in near real time relative to the captured image frames.

### E. Technical Effects and Improvement of Computer Technology

The server and the terminal cooperate to implement a specific data flow and algorithmic sequence that improves computer-based image analysis and communication beyond generic automation of human tasks.

The server reduces network bandwidth and improves latency by converting high-dimensional image data into compact structured data that contain only safety-critical fields. Because the server includes a semantic extraction module that coerces the generative AI model's free-form text outputs into fixed fields (signal state, permission or prohibition of passage, cautionary information), the terminal does not need to run heavy models or parse long texts and can operate with limited computational resources.

The server improves processing efficiency by using context-specific prompt sentences that constrain the generative AI model to relevant semantics. Instead of using a generic captioning prompt, the server directs the model toward traffic-related cues and navigational hazards.

This focus reduces the complexity of the generated text, improves interpretability, and allows more aggressive optimization of decoding parameters. Because the prompt sentences are dynamically generated according to mobility-assistance context, the server can re-use the same generative AI model for multiple scene types while preserving low-latency, high-relevance responses.

The server implements a non-conventional flow in which the generative AI model is used not only to produce human-readable descriptions but also to produce intermediate representations that are machine-parseable. By designing the prompt sentences and the semantic extraction module together, the system forms a feedback loop that stabilizes the structure of natural language outputs. This improves the reliability of mapping into structured data and reduces error in downstream speech synthesis.

The generative AI model uses a neural architecture and training procedure that are not equivalent to human mental processes. The model uses high-dimensional embeddings, attention weights, and gradient-based training with loss minimization over large datasets. The server uses explicit error functions and optimizer algorithms to calibrate the model's parameters. The server uses normalizations and augmentations that are not typically performed by human operators, such as batch normalization across images or augmentation-driven invariances, resulting in improved generalization and robustness in diverse lighting and weather conditions.

Because the server and the terminal perform these operations within a distributed architecture that accounts for constraints of wearable devices and mobile networks, the system achieves a technical improvement in several respects: reduced communication load, improved end-to-end processing speed, increased accuracy of signal and obstacle detection in noisy urban scenes, and more reliable timing and clarity of audio output.

### F. Examples of Operation and Alternative Embodiments

In one example, the user approaches a signalized crosswalk. The terminal captures images of the intersection and sends them to the server. The server generates a prompt sentence focused on pedestrian signals and crosswalks, such as:
“You are assisting a visually impaired user at a crosswalk. Examine the image and answer in one short sentence: what is the color of the pedestrian signal, and is it safe to cross now?”

The generative AI model outputs a sentence such as “The pedestrian light is red. It is not safe to cross now; please wait.” The server extracts a signal state “red” and a safety evaluation “not safe to cross” and sends structured data with a narration text such as “The signal is red. Please wait.” The terminal synthesizes and outputs this message. When the signal turns green, the server produces a different natural language sentence and structured data, and the terminal outputs “The signal is green. Please cross now, but watch for cars on your left.”

In another example, the user walks along a narrow sidewalk with obstacles. The server changes the prompt sentence to emphasize ground-level hazards and obstacles. The prompt sentence may be:
“You are a navigation assistant for a blind person. Look at the image and describe only obstacles on the ground, steps, and vehicles or bicycles that may interfere with walking. Respond in one short sentence.”

The generative AI model may output “There is a bicycle lying on the sidewalk about two meters ahead; please slow down and go around it.” The server extracts an obstacle type, distance indication, and cautionary instruction, and the terminal notifies the user accordingly.

In an alternative embodiment, the server uses a different neural architecture, such as a convolutional backbone followed by a recurrent decoder or a hybrid CNN-transformer model.

The server may also use different training datasets or fine-tuning strategies to target particular environments such as indoor malls or railway stations. The prompt generation module may be replaced by a template-based system or may incorporate simple rule engines that select different prompts based on time of day, GPS location, or feedback from the terminal about user preferences.

In another embodiment, part of the analysis is performed on the terminal, using a smaller generative AI model or a distilled version of the server model for offline scenarios. In this case, the terminal still uses the same concept of context-specific prompt sentences and structured data mapping, but executes the model locally when network connectivity is poor. The same data structures and prompts allow switching seamlessly between server-side and terminal-side processing, maintaining consistent behavior and preserving the benefits of the designed pipeline.

Because the server and the terminal cooperate through concrete data structures, algorithmic steps, and prompt-controlled generative processing, and because the system produces real-time control over audio output devices in response to physical environmental stimuli, the described embodiments go beyond an abstract idea and realize a practical application that improves the functioning of computer systems for assistive navigation.

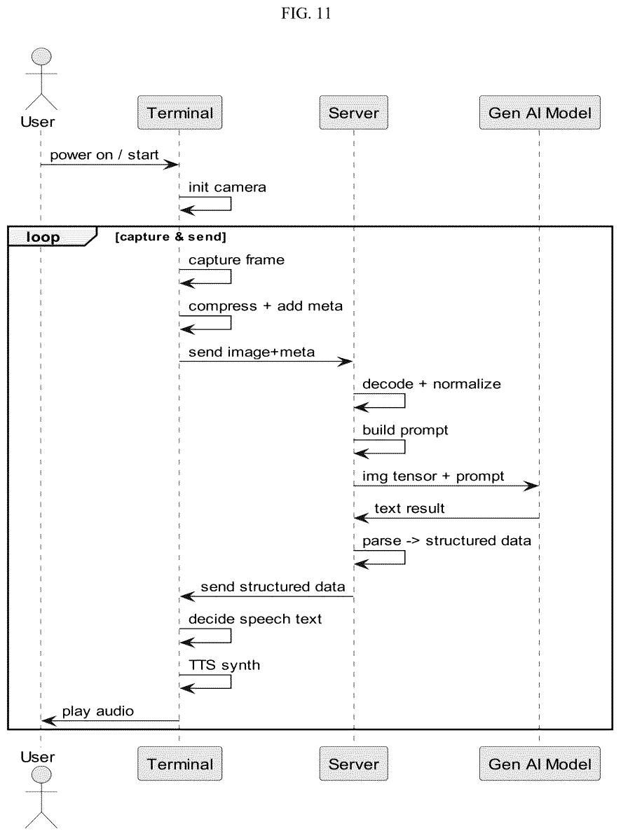

The following describes the processing flow using FIG. 11.

### Step 1:

User wears the terminal and starts mobility.
User places the terminal, such as smart glasses, on the head and powers on the device.
Input: User's physical action of wearing and powering on the terminal.
Output: Terminal is in an active state with sensors and communication modules initialized.
User optionally activates a guidance application on the terminal by pressing a physical button on the frame or by issuing a voice command.
User thereby causes the terminal to start a continuous guidance session.

### Step 2:

Terminal initializes the image acquisition device.
Terminal uses a camera framework, such as an Android Camera2 API or an iOS AVFoundation API, to open the camera and configure resolution, frame rate, exposure, and focus parameters.
Input: Configuration parameters stored in the terminal memory (for example, 1920×1080 resolution, 30 fps).
Output: A configured camera pipeline ready to deliver raw image frames.
Terminal allocates buffers in memory to receive image frames from the image sensor and to queue them for further processing.

### Step 3:

Terminal captures image data of the surrounding situation.
Terminal controls the image acquisition device to capture a sequence of frames that represent the user's forward field of view in real time.
Input: Photons from the real-world environment and camera configuration from Step 2.
Output: Raw image frames in a sensor-specific format (for example, YUV or Bayer pattern).
Terminal converts raw frames into RGB data and optionally corrects lens distortion and white balance using image-processing functions.
Terminal thereby produces a stream of digital image frames representing the current environment of the user.

### Step 4:

Terminal compresses and packages image data with metadata.
Terminal applies an image compression codec, such as JPEG encoding using a media codec library, to reduce the size of each frame.
Input: Raw or RGB image frames from Step 3.
Output: Compressed image data (for example, JPEG byte arrays).
Terminal appends metadata, including timestamp, approximate position, and device orientation, and forms a data packet or message structure.
Terminal thereby produces a transmission-ready payload containing compressed image data and contextual metadata.

### Step 5:

Terminal transmits the image data to the server.
Terminal uses a communication control device, such as a wireless communication module, to establish a secure connection (for example, HTTPS over TCP/IP) to the server.
Input: Transmission-ready payload from Step 4 and network configuration stored on the terminal.
Output: Network request sent to the server containing compressed image data and metadata.
Terminal sends an HTTP POST request or a remote procedure call containing the payload to a predefined server endpoint and waits for a response while continuing to capture subsequent frames.
Terminal thereby streams current scene information to the server at short intervals.

### Step 6:

Server receives and decodes the image data.
Server uses a web framework to receive the network request from the terminal and parses the request body to extract the compressed image bytes and associated metadata.
Input: Network request from Step 5.
Output: In-memory compressed image data and structured metadata on the server.
Server invokes an image-processing library, such as OpenCV or Pillow, to decode the compressed bytes into a numeric pixel array in RGB format.
Server converts the numeric pixel array into a tensor representation suitable for machine learning operations.

### Step 7:

Server normalizes the image tensor for the generative AI model.
Server applies preprocessing operations such as resizing, cropping, and pixel-value scaling to align the image tensor with the expected input format of the vision encoder of the generative AI model.
Input: RGB pixel tensor from Step 6.
Output: Normalized image tensor with fixed dimensions and normalized value range.
Server may perform channel reordering, mean-subtraction, and variance-scaling according to stored normalization parameters associated with the trained model.
Server thereby ensures that the image input is numerically compatible with the generative AI model's training conditions.

### Step 8:

Server determines the mobility-assistance context.
Server analyzes metadata (for example, location, recent history of results, or application mode) to infer whether the user is near an intersection, walking along a sidewalk, or in another scenario.
Input: Metadata from Step 6 and stored context state from previous requests.
Output: A context label or context parameters indicating a current mobility-assistance situation.
Server updates a context state machine or rule set to reflect transitions, such as “approaching crosswalk” or “obstacle-dense environment.”

### Step 9:

Server generates a context-specific prompt sentence.
Server uses the mobility-assistance context from Step 8 to select or synthesize a prompt sentence that specifies which features to analyze and how to express the output.
Input: Context label from Step 8 and stored prompt templates.
Output: Prompt sentence in natural language.
Server may fill placeholders in a template, for example:
“You are assisting a visually impaired user who is approaching a crosswalk. Examine the image and answer briefly: what is the color of the pedestrian traffic signal, and is it safe to cross now?”
or
“You are a navigation assistant for a blind person. Look at the image and describe only safety-relevant information in one or two short sentences: traffic lights, crosswalks, obstacles on the ground, approaching vehicles, bicycles, and steps.”
Server thereby tailors the generative AI model behavior to a particular safety-focused analysis.

### Step 10:

Server constructs the multimodal input for the generative AI model.
Server tokenizes the prompt sentence using a tokenizer associated with the language model, mapping characters or words to token identifiers.
Input: Prompt sentence from Step 9 and normalized image tensor from Step 7.
Output: Token sequence representing the prompt and prepared image tensor for the vision encoder.
Server passes the normalized image tensor to the vision encoder and obtains initial visual embeddings, or defers this operation to the generative AI framework if integrated.
Server creates a multimodal representation linking the token sequence and the image embeddings by using designated special tokens or data structures, preparing the combined input for inference.

### Step 11:

Server performs feature extraction with the vision encoder.
Server inputs the normalized image tensor into the vision encoder component of the generative AI model, which may be implemented as a convolutional network or a vision transformer.
Input: Normalized image tensor from Step 7.
Output: Visual feature embeddings, such as a set of vectors for image regions or a global feature vector.
Server executes matrix multiplications and non-linear activation functions according to the trained model parameters, producing high-dimensional feature vectors that capture shapes, colors, and spatial relationships.
Server thereby transforms pixel-level data into semantic features suitable for language-conditioned reasoning.

### Step 12:

Server generates a natural language analysis result using the generative AI model.
Server feeds the visual feature embeddings and the tokenized prompt sentence into the language decoder of the generative AI model.
Input: Visual feature embeddings from Step 11 and token sequence from Step 10.
Output: Generated natural language sentence describing safety-relevant aspects of the scene.
Server performs transformer-based attention operations that relate visual features to prompt tokens, and then computes probability distributions over output tokens at each generation step.
Server selects output tokens using a decoding method, such as greedy decoding or beam search, until an end-of-sentence condition is met, producing a sentence such as “The pedestrian light is red. It is not safe to cross now; please wait.”
Server thereby produces a compact, context-aware natural language description of the analyzed scene.

### Step 13:

Server extracts structured information elements from the natural language sentence.
Server parses the generated sentence using rule-based patterns and optionally lightweight classifiers to identify phrases that correspond to signal state, permission or prohibition of passage, and cautionary information.
Input: Natural language sentence from Step 12.
Output: Structured information elements, for example signal_state=“red”, safe_to_cross=false, caution=“please wait.”
Server applies string matching, regular expressions, or shallow semantic parsing to detect keywords and patterns such as “red”, “green”, “safe to cross”, “not safe”, “car approaching”, and maps them to predefined fields.
Server thereby converts an unstructured text output into a machine-readable representation.

### Step 14:

Server generates structured data for transmission to the terminal.
Server organizes the extracted information elements into a data structure, such as a record with named fields representing signal state, permission or prohibition of passage, cautionary information, and an associated narration text.
Input: Information elements from Step 13.
Output: Structured data object containing safety-relevant fields and a concise narration string.
Server may include additional fields, such as confidence scores or a recommended timing for the next update.
Server serializes the structured data into a transferable format and prepares a response message directed to the terminal.

### Step 15:

Server transmits the structured data to the terminal.
Server sends a response message through the network interface back to the terminal using the same secure communication channel established earlier.
Input: Serialized structured data from Step 14 and connection information associated with the terminal.
Output: Network response containing structured safety data delivered to the terminal.
Server thereby completes a processing cycle, providing low-bandwidth, semantically rich information to the terminal.

### Step 16:

Terminal receives and parses the structured data.
Terminal obtains the response from the server via its communication control device and passes the payload to a parser module.
Input: Network response from Step 15.
Output: In-memory structured data, including signal state, safety evaluation, and narration text.
Terminal decodes the serialized format and maps each field to internal variables in the guidance application.
Terminal thereby obtains clear, machine-usable safety information for immediate use.

### Step 17:

Terminal determines audio output parameters based on the structured data.
Terminal analyzes the signal state and safety evaluation fields to decide whether to instruct the user to stop, wait, or proceed.
Input: Structured data from Step 16 and terminal-side context such as recent messages and user preferences.
Output: Determination of message content, length, and output frequency, and settings for volume and speaking rate.
Terminal considers the movement speed of the user and the ambient sound level, and computes adjustments to audio parameters to maintain intelligibility without masking environmental sounds.
Terminal thereby adapts the guidance behavior to both the semantic content and physical context.

### Step 18:

Terminal generates speech text for synthesis.
Terminal selects narration text from the structured data or constructs it from field values according to templates.
Input: Structured data and audio output parameters from Step 17.
Output: Final text string to be sent to the text-to-speech engine.
Terminal may shorten or simplify the narration text based on configured maximum length, for example changing “The pedestrian light is red. It is not safe to cross now; please wait.” to “The signal is red. Please wait.”
Terminal thereby prepares a speech-optimized sentence tailored to the current situation.

### Step 19:

Terminal synthesizes audio data from the text.
Terminal invokes a text-to-speech engine on the terminal processor, passing the prepared text string and audio parameters such as language, speaking rate, and volume.
Input: Speech text from Step 18 and audio settings from Step 17.
Output: Audio data representing spoken guidance, for example a PCM waveform or encoded audio frames.
Terminal executes the speech synthesis algorithm, which includes text normalization, phoneme conversion, prosody generation, and waveform synthesis according to the selected voice model.
Terminal thereby transforms structured semantic guidance into an audible signal.

### Step 20:

Terminal outputs the audio guidance to the user.
Terminal sends the audio data to the acoustic output device through an audio playback API, scheduling audio frames for real-time playback.
Input: Audio data from Step 19 and state of the acoustic output device.
Output: Audible sound that conveys safety instructions to the user.
Terminal monitors playback to avoid overlapping messages and may interrupt or prioritize urgent warnings, such as sudden detection of an approaching vehicle or a step.
Terminal thereby provides timely, context-aware guidance that the user can hear while moving.

### Step 21:

User reacts to the audio guidance in real-world movement.
User listens to the spoken instructions emitted by the terminal and adjusts walking behavior accordingly, such as stopping at a red signal or proceeding when the signal is green.
Input: Audible guidance from Step 20.
Output: Changed physical movement of the user, such as stopping, slowing down, or starting to walk.
User may continue walking, change direction, or wait, which in turn changes the scene captured by the image acquisition device and initiates further cycles of the processing flow.
User thereby closes the loop between computational analysis and physical mobility in the real environment.

### Application Example 1

Description follows regarding a flow of the specific processing in an Application Example 1. The units of the system described below are implemented by the data processing device 12 and the smart device 14. The data processing device 12 is called a “server” and the smart device 14 is called a “terminal”.

Conventional assistive systems that convert visual information into audio guidance typically rely on task-specific algorithms or static rule-based logic to detect obstacles or hazards in camera images. Such systems often require carefully engineered feature extraction pipelines and pre-defined classification models that are rigid, difficult to adapt to new environments, and sensitive to variations in lighting, viewpoint, and scene complexity. As a result, the reliability and robustness of hazard detection and situational understanding are limited, particularly in dynamic real-world environments such as crowded public spaces or large facilities under surveillance.

Further, many existing solutions perform image analysis and audio generation as loosely coupled modules, without a unified mechanism to express high-level analysis goals to an underlying model. In particular, there is no standardized way to capture user-specific context, such as whether the user is visually impaired or acting as a security guard, and to incorporate that context into the image analysis logic. This prevents the system from tailoring its analysis and output to the user's role or behavioral situation and leads to generic, sometimes irrelevant, notifications.

In recent years, generative AI models that accept natural language prompts have become capable of performing flexible multimodal reasoning, including interpretation of image content. However, conventional systems do not systematically exploit such generative AI models as a central analysis engine that is driven by dynamically generated prompt sentences reflecting real-time video content and user context. In particular, existing systems fail to define a processing architecture in which a processor continuously (i) captures moving image information, (ii) generates structured analysis instruction texts as prompt sentences, (iii) obtains semantically rich analysis results from a generative AI model, and (iv) converts the results into concise, context-aware audio guidance in real time.

Moreover, from a computer-technology perspective, known systems do not provide a closed-loop, periodic processing pipeline optimized for low-latency, continuous monitoring. They lack an integrated control mechanism whereby a processor orchestrates capture, preprocessing, prompt construction, remote model invocation, result post-processing, and audio presentation at a predetermined cycle. This can result in increased latency, inconsistent update intervals, and inefficient use of computational and communication resources, which degrades the user's real-time awareness and the practical safety support offered by the system.

Accordingly, there is a need for a computer-implemented technique that improves the way an information processing apparatus uses a generative AI model by (i) dynamically generating prompt sentences that encode both visual input and user-specific analysis objectives, (ii) structuring the interaction with the generative AI model as part of a periodic, low-latency processing loop on moving image information, and (iii) transforming rich semantic analysis results into concise, role-adaptive audio guidance for continuous, real-time hazard notification. This represents a technical improvement in computer technology, specifically in how a processor controls image capture, network-based model invocation, and multimodal output generation to provide robust, context-aware situational assistance.

The specific processing by the specific processing unit 290 of the data processing device 12 in Application Example 1 is realized by the following means.

The present invention provides a server comprising a processor configured to control an image capturing device to continuously capture a surrounding environment and generate moving image information, preprocess the moving image information and transmit the preprocessed moving image information to an information analysis apparatus, generate an analysis instruction text including the moving image information and an analysis purpose corresponding to at least one of a user attribute and a usage situation, input the analysis instruction text as a text-format prompt sentence to a generative information processing model, acquire analysis result information from the generative information processing model, generate, on a basis of the analysis result information, a concise description text indicating at least one of a potential hazardous event and a safe state, control an audio information conversion apparatus to convert the description text into audio information and transmit the audio information to a portable information terminal, control the portable information terminal so as to present the audio information to a user in real time via an acoustic output device, and repeatedly execute, at a predetermined cycle, acquisition of the moving image information, generation of the analysis instruction text, analysis by the generative information processing model, and presentation of the audio information. This enables an improved computer-implemented processing pipeline in which the server efficiently orchestrates continuous image capture, context-aware prompt construction, generative AI-based image analysis, and real-time audio output, thereby reducing latency, enhancing robustness and adaptability of hazard detection, and providing technically improved, role-specific situational awareness to the user through optimized use of computational and communication resources.

The term “processor” refers to a hardware-implemented information processing unit, such as a central processing unit, a microcontroller, a digital signal processor, or a combination thereof, that executes instructions to perform control, computation, and data processing operations described in the present specification.

The term “system” refers to an arrangement including at least one processor, one or more memory units, one or more communication interfaces, and one or more external devices, which cooperate to execute the functions, operations, and processes described in the present specification.

The term “image capturing device” refers to an electronic apparatus that acquires visual information of a physical environment and outputs corresponding digital image data, and includes, for example, a camera module, a video sensor, or an imaging unit integrated into wearable equipment or other terminal equipment.

The term “information processing apparatus” refers to an electronic apparatus including at least one processor and a memory, configured to control peripheral devices, execute software, and perform data processing on image information, audio information, or other types of information.

The term “moving image information” refers to a sequence of image frames or video data representing temporal changes of a scene in a surrounding environment, acquired by the image capturing device over time and processed as digital data by the processor.

The term “image processing functionality” refers to hardware or software functions that perform operations on image data, such as resizing, format conversion, color space conversion, compression, noise reduction, or other transformations, prior to analysis by an external or remote analysis apparatus.

The term “information analysis apparatus” refers to an electronic apparatus, which may be local or remote with respect to the information processing apparatus, that receives preprocessed information, executes analytical operations including use of a generative information processing model, and returns analysis result information.

The term “analysis instruction text” refers to a text string generated by the processor that describes analysis objectives, conditions, or tasks to be performed by a generative information processing model with respect to input information such as moving image information.

The term “analysis purpose” refers to an intended analytical goal or task, such as detection of potential hazardous events, recognition of target elements, or assessment of a safety state, which the processor encodes into the analysis instruction text for consumption by the generative information processing model.

The term “user attribute” refers to information indicating a characteristic or role of a user, such as being visually impaired, being a security personnel, or having a specific skill level, which is used to customize the analysis purpose and the content of guidance provided to the user.

The term “usage situation” refers to contextual information regarding a current operational environment or behavioral state, such as a location, time period, patrol mode, or movement state of the user, which influences how the processor formulates the analysis purpose and the analysis instruction text.

The term “prompt sentence” refers to a text-format instruction, typically in natural language, that is provided as input to a generative information processing model in order to specify an analysis task, constrain the model's behavior, or request a particular form of output.

The term “generative information processing model” refers to a machine-learned model, such as a generative AI model, that is capable of accepting a prompt sentence and input data including image data, performing inference based on learned parameters, and generating output information such as descriptive text or analysis result information.

The term “analysis result information” refers to information output by the generative information processing model in response to an analysis instruction text and associated input data, the information including, for example, detected objects, interpreted scenes, potential hazardous events, and safety assessments.

The term “potential hazardous event” refers to an event or condition inferred from the analysis result information that may pose a risk of harm or danger to the user or to an asset, such as approach of a suspicious person, presence of an obstacle, or existence of a moving vehicle in the path of the user.

The term “safe state” refers to a condition inferred from the analysis result information indicating that no immediate potential hazardous event has been detected within a monitored environment for the user under the current circumstances.

The term “description text” refers to a text string generated by the processor based on the analysis result information, summarizing at least one of a potential hazardous event and a safe state in a concise, human-understandable manner.

The term “guidance text” refers to a type of description text that further includes an instruction or recommended action for the user, generated based on the analysis result information and at least one of a role of the user and a behavioral situation of the user.

The term “audio information conversion apparatus” refers to hardware or software, or a combination thereof, configured to perform text-to-speech conversion or other audio signal generation, in order to convert text data such as the description text or the guidance text into audio data suitable for playback.

The term “portable information terminal” refers to a mobile or wearable electronic device, such as a smartphone, a head-mounted device, or smart glasses, including at least one processor, a memory, a communication interface, and an audio output interface, which is configured to receive and present audio information to the user.

The term “communication path” refers to a logical or physical communication channel, such as a wired link or a wireless link using radio communication technology, that enables transfer of data including moving image information or audio information between the server, the information analysis apparatus, and the portable information terminal.

The term “acoustic output device” refers to a device for outputting audio signals to the user, such as an earphone, a speaker, or a bone-conduction transducer, which is connected to or integrated into the portable information terminal.

The term “role of the user” refers to a functional position or duty of the user within a given context, such as security personnel, maintenance personnel, or general pedestrian, which influences the type and priority of information provided by the system.

The term “behavioral situation of the user” refers to a state or pattern of movement or activity of the user, such as walking, standing, patrolling, or approaching a particular area, which is used to adapt the content and timing of notifications.

The term “predetermined cycle” refers to a time interval defined by configuration or by control logic, at which the processor repeatedly executes a series of operations including acquisition of moving image information, generation of the analysis instruction text, analysis by the generative information processing model, and presentation of audio information.

The server, the terminal, and the user cooperate to implement the invention as described below. The following embodiments are exemplary and do not limit the scope of the claims.

The server includes at least one processor, a main memory, a non-volatile storage device, and a network interface. The server executes an operating system, a camera capture library such as a general-purpose image processing library, a client library for accessing a remote generative AI model, and a text-to-speech engine. The server is connected, via a wired or wireless network, to the terminal and, optionally, to an external information analysis apparatus that hosts or proxies a generative AI model.

The terminal includes a wearable housing, such as a head-mounted frame or glasses-type housing, an image capturing device, an audio output device, a short-range wireless communication module, and a local processor. The terminal executes an embedded operating environment (for example, a mobile operating system or a real-time operating system) and a communication program that sends image data to the server and receives audio data from the server. The image capturing device includes a solid-state imaging sensor, optics, and an interface circuitry, and is configured to continuously capture a user's field of view. The audio output device includes at least one transducer such as an earphone, a speaker, or a bone-conduction element attached to the wearable housing.

The user wears the terminal so that the image capturing device faces forward and the audio output device is positioned near the user's ear or skull. The user moves in an environment such as a public space, a facility corridor, or an outdoor sidewalk. The user can change system settings, such as selecting a user role (for example, visually impaired person or security personnel), via a companion application or a simple physical interface on the terminal.

The server stores, in the main memory or the non-volatile storage, executable modules including an image acquisition module, an image preprocessing module, a prompt generation module, a generative model interaction module, a result interpretation module, and an audio output control module. These modules cooperate to implement the functions recited in the claims.

The server controls the image capturing device of the terminal via the communication module of the terminal. The server instructs the terminal to operate the image capturing device in a continuous capture mode, in which frames are acquired at a fixed rate (for example, 10-30 frames per second). The terminal acquires raw image frames in a sensor-specific format and either forwards them directly to the server or applies lightweight compression at the terminal side, such as converting raw sensor data to a compressed video stream.

The server receives image data via the network interface and stores each frame temporarily in a buffer in the main memory. The server uses the image processing library to perform concrete image processing operations on each frame. The server resizes each frame to a prescribed resolution (for example, 640×480 pixels) by performing interpolation on the pixel matrix. The server converts the color encoding from a device-specific format to a standard color space (for example, from device BGR to RGB), and the server optionally performs normalization of pixel values (for example, scaling pixel intensities to a fixed floating-point range) to conform to the input requirements of the generative AI model.

The server converts the processed image frame into an encoded image representation, such as a compressed JPEG or PNG byte array. The server stores this encoded representation together with metadata such as a timestamp, a frame identifier, and user-context information (role, location category, time-of-day category) in a structured in-memory record. The server uses this record as an input data structure to the prompt generation module and the generative model interaction module.

The server generates a prompt sentence as an analysis instruction text for the generative AI model. The server constructs the prompt sentence by combining (i) a static template that describes the role and objective, (ii) dynamic fields containing user attributes and usage situation, and (iii) constraints specifying the required output format. The server selects one of several templates according to the current user role.

For example, when the user is a visually impaired person, the server can generate a prompt sentence such as:
“You are assisting a visually impaired person who is walking outdoors. Analyze this image and describe any potential danger, such as obstacles, moving vehicles, bicycles, uneven ground, or steps. Provide a short summary of the scene and a clear instruction on what the user should do next.”

When the user is security personnel, the server can generate a prompt sentence such as:
“You are assisting a security guard who is patrolling a facility at night. Analyze this image and determine whether there is any potential danger, such as suspicious movement, a suspicious person, or an intruder. Describe briefly what you see and state clearly whether an alert should be raised.”

The server may further generate prompt sentences that explicitly request recognition of objects and text in the image, such as:
“Analyze this image and recognize any objects, people, vehicles, signs, or text. Explain whether any recognized element indicates a potential hazardous event or a safe state. Provide a concise explanation and a recommended action.”

The server sends the prompt sentence and the encoded image data to the information analysis apparatus hosting the generative AI model. The server uses a client library to construct a request message containing the prompt, the encoded image, and parameters specifying model behavior, such as a target maximum token length or response constraints. The server transmits this request via an encrypted transport protocol. The generative AI model resides on computing hardware, such as one or more graphics processing units or tensor processing units, and implements a neural network architecture capable of multimodal processing.

In one embodiment, the generative AI model is implemented as a transformer-based neural network that includes an image encoder and a text decoder. The image encoder converts an input image into a sequence of visual feature embeddings by applying multiple layers of convolution, attention mechanisms, and normalization. The text decoder receives the prompt sentence as a sequence of token embeddings and attends jointly to both the prompt tokens and the visual feature embeddings. The model is trained to predict output tokens autoregressively, using a cross-entropy loss function that compares predicted tokens to target tokens in training data. The model parameters, including weight matrices of attention layers and feed-forward layers, are updated using gradient-based optimization such as stochastic gradient descent or Adam. The training data includes pairs of images and textual descriptions that cover safety-related scenarios, such as obstacles, suspicious behaviors, and normal conditions, as well as context-rich dialogues for different user roles.

The server does not modify the internal parameters of the deployed generative AI model during operation, but the server controls model invocation by specifying the prompt sentence and by providing the image as a separate input modality. The server thereby steers the inference process of the generative AI model to focus on hazard detection, semantic interpretation of the scene, and user-specific guidance.

The server receives analysis result information from the information analysis apparatus in the form of a structured response. The response includes at least a natural-language description of the scene, references to detected objects or hazards, and recommended actions. The server parses the response using a JSON parsing module or other structured data parser. The server separates the scene description, the hazard evaluation (for example, “no immediate danger” or “potential intruder detected”), and the recommended action. The server then generates a concise description text by summarizing or rephrasing the analysis result according to predefined summarization rules.

For instance, if the generative AI model produces a long description such as:
“In the image, there is a narrow sidewalk with a parked bicycle blocking most of the path about two meters ahead of the user. A car is passing by on the road to the left. Potential danger: collision with the bicycle if the user continues straight. Recommended action: the user should slow down and step slightly to the right to avoid the bicycle.”

the server generates a concise description text such as:
“A bicycle is blocking the sidewalk about two meters ahead. Please slow down and move slightly to the right.”

The server controls a text-to-speech engine as the audio information conversion apparatus. The server provides the concise description text as input to the text-to-speech engine, specifies voice characteristics (gender, language, speed, volume), and generates audio output data, for example in a linear PCM or compressed audio format. The server may adjust the speaking rate and volume in accordance with the detected level of urgency in the analysis result information. If the generative AI model indicates a high-risk hazard, the server can set a higher volume and a faster, more urgent speech style.

The server transmits the generated audio data to the terminal over a wireless communication path. The terminal receives the audio data, decodes it if necessary, and supplies it to the audio output device through the terminal's audio driver. The user hears the spoken guidance in real time and can adapt movement or behavior accordingly. For example, the user can stop walking, change direction, or increase attention based on the instructions such as:
“Suspicious movement detected ahead on your right. Please stop and be cautious.”
or
“No immediate danger detected. You can continue straight.”

The server improves computer technology by implementing a specific processing architecture and data flow that are different from simple automation of human observation. The server records moving image information as a time-stamped sequence of frames and processes them at a predetermined cycle with strict latency constraints. The server maintains a frame queue, a request queue to the generative AI model, and a response queue, and the server schedules operations so that each frame is analyzed within a target time budget. By using image preprocessing to reduce resolution and compress data, the server reduces communication load and decreases round-trip time between the server and the information analysis apparatus. The server thereby increases throughput and decreases delay in hazard notification compared to a naive approach that sends full-resolution frames without compression or context-aware prompt control.

The server improves accuracy and robustness by using the generative AI model in a structured manner. Rather than relying solely on low-level object detection models or static rule sets, the server encodes high-level safety questions and user-role-specific objectives into the prompt sentence. Because the generative AI model attends to both the prompt and the visual features, the model can interpret the scene in a way that aligns with the safety objectives. This reduces false positives and false negatives in hazard detection compared to systems that classify images without contextual prompt information. The server can also implement thresholding rules on the generative AI model output, such as interpreting specific phrases (“possible intruder,” “obstacle directly in front”) as triggers for high-priority alerts, and ignoring generic comments that do not indicate hazards.

The server enhances computational efficiency by reusing context over time. In one embodiment, the server maintains a rolling representation of recent frames and incorporates references to temporal continuity in the prompt sentence, such as:
“Compared with the previous frame, identify any new potential danger in this image and describe only the change that is relevant for the user.”

This approach allows the generative AI model to focus on changes instead of re-describing the entire scene, which reduces the amount of data that needs to be spoken and decreases cognitive load on the user. The server can also adapt the processing frequency based on motion detection. If the server detects that consecutive frames are nearly identical using a fast pixel-wise or histogram-based similarity metric, it can skip sending some frames to the generative AI model, thereby reducing computational and communication overhead.

The server uses a neural network architecture that is trained with domain-specific data for safety and guidance, and the server leverages this trained representation to perform multimodal reasoning that humans cannot easily replicate in real time. The training process employs data augmentation techniques such as random cropping, rotation, brightness changes, and occlusion simulation to expose the model to diverse conditions, which increases robustness under varying lighting and viewpoint. The server thus obtains improved performance compared to conventional rule-based systems that would require extensive manual tuning to handle such variability.

The server applies non-conventional control logic in combining the generative AI model with deterministic post-processing rules. For example, the server applies a custom mapping from generative model outputs to internal hazard levels using pattern matching on key phrases or tokens and structured tags in the response. The server can assign numeric hazard scores and smooth these scores over time using exponential moving averages to avoid oscillating alerts. If the hazard score crosses a threshold, the server generates an urgent guidance text; otherwise, the server may generate a reassurance message indicating a safe state. This combination of generative analysis and deterministic smoothing is specifically configured for real-time safety support and is not a simple automated replacement of a human operator.

The server, in some embodiments, integrates additional sensor information, such as inertial data from the terminal (accelerometer, gyroscope), and supplies summary values (for example, current walking speed or head orientation) as part of the usage situation in the prompt sentence. For instance, the server may generate a prompt such as:
“The user is walking quickly and the camera is slightly tilted downwards. Analyze the image and check particularly for obstacles or steps directly in front of the user's feet. Provide a short instruction on whether the user should slow down, stop, or change direction.”

By incorporating such sensor-derived context, the server improves the relevance and precision of the generative AI model's analysis, leading to a lower rate of missed obstacles close to the user's path.

The server may be implemented in several variants. In one embodiment, the generative AI model executes on a remote cloud-based analysis platform. In another embodiment, the generative AI model executes on an edge computing node located near the access point, which reduces network latency. In yet another embodiment, a smaller generative model runs locally on the terminal for basic hazard detection, and the server invokes a larger remote model only when the local model indicates uncertainty. These alternative configurations demonstrate that the technical features of the invention, such as prompt-based multimodal analysis and continuous, low-latency guidance, can be realized on different hardware topologies while preserving the claimed functions.

The terminal can also be varied. In one embodiment, the terminal is a pair of smart glasses with an integrated camera and bone-conduction speakers. In another embodiment, the terminal is a helmet-mounted device used in industrial environments. In a further embodiment, the terminal is a handheld device with a camera and earphones. In all cases, the terminal provides a physical mounting for the camera that captures the user's perspective and an audio pathway by which the user can receive real-time spoken guidance.

The user interacts with the system primarily through movement and limited configuration input. The user may, for example, switch between “quiet” and “detailed” modes, in which the server either provides only high-urgency alerts or also provides general scene descriptions. The server adapts the prompt sentence and post-processing accordingly, which demonstrates that the invention can flexibly accommodate different operational needs while maintaining the same underlying technical architecture.

By structuring data, algorithms, and hardware in the manner described above, the server improves the operation of computer systems responsible for real-time environmental monitoring and guidance. The system does not merely automate human reading of images; instead, the system introduces a specific technical arrangement in which image preprocessing, prompt sentence generation, generative model invocation, temporal hazard smoothing, and text-to-speech conversion are combined to achieve reduced latency, improved accuracy, and efficient resource utilization in a continuous monitoring environment. This results in a concrete technological improvement in the field of computer-implemented situational awareness and hazard notification.

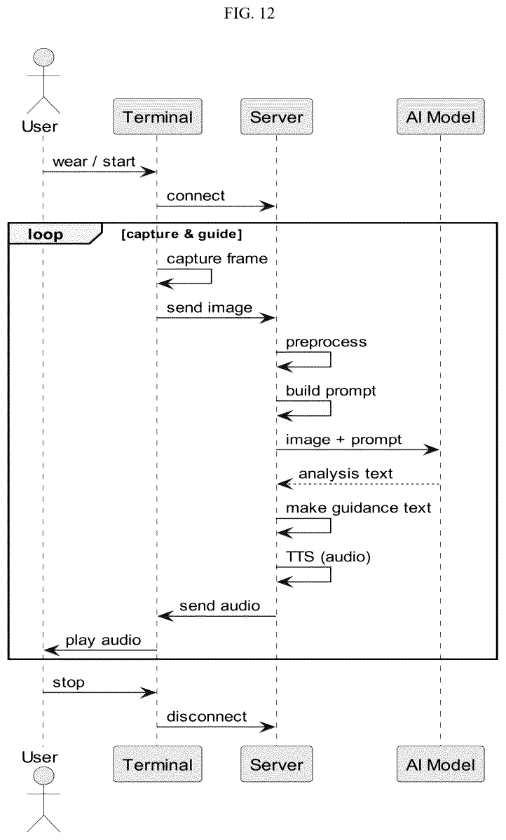

The following describes the processing flow using FIG. 12.

### Step 1:

The server initializes system resources.
The server loads an operating system, an image processing library, a network communication library, a client library for a generative AI model, and a text-to-speech engine into memory.
The input is configuration data specifying camera parameters, network addresses, user role, and processing frequency. The server parses this configuration and stores it in internal data structures. The output is an initialized runtime environment in which all required modules are ready to operate.

### Step 2:

The terminal establishes a connection with the server.
The terminal powers on its wireless communication module and sends a connection request containing device identifiers and capabilities to the server. The input is device-specific information such as supported image resolution, frame rate, and audio formats. The terminal transmits this information to the server. The output is an established communication session with agreed parameters for image streaming and audio reception.

### Step 3:

The server configures the image capturing device of the terminal.
The server sends control commands to the terminal to set the camera into a continuous capture mode with predetermined resolution and frame rate. The input is the device capability information received in Step 2 and the server's processing constraints. The server computes appropriate capture parameters (for example, 640×480 pixels at 15 frames per second) and sends them as control messages. The output is a configured camera on the terminal, ready to deliver frames continuously.

### Step 4:

The terminal captures raw image frames.
The terminal operates the camera sensor to acquire visual information from the user's field of view in real time. The input is the camera configuration (exposure, gain, frame rate) set in Step 3. The terminal converts analog sensor signals into digital image frames in a raw or native format. The output is a sequence of raw image frames stored temporarily in the terminal's memory.

### Step 5:

The terminal transmits image frames to the server.
The terminal compresses or packetizes each raw frame, for example by encoding it into a compressed image format or packaging it into network packets, and sends it through the wireless link to the server. The input is the raw frames produced in Step 4. The terminal performs data formatting and optional compression to reduce size. The output is a stream of encoded image data packets received by the server's network interface.

### Step 6:

The server receives and buffers the image frames.
The server reads incoming packets from the network interface, reassembles them into complete encoded images, and stores them in a frame buffer in main memory. The input is the encoded image packet stream from the terminal. The server validates packet sequence numbers and checks integrity (for example, via checksums). The output is a time-ordered buffer of encoded image frames ready for further processing.

### Step 7:

The server decodes and preprocesses the image frames.
The server uses the image processing library to decode each encoded image into a pixel matrix (for example, a three-channel array). The input is the encoded frame stored in the buffer. The server performs data operations including decoding, resizing to a target resolution, color space conversion (for example, BGR to RGB), and normalization of pixel values. The output is a normalized image tensor suitable as input to the generative AI model.

### Step 8:

The server associates context metadata with each frame.
The server obtains or updates context information such as timestamp, user role (visually impaired user or security guard), current mode (patrol, walking, standing), and possibly location category. The input is the normalized image tensor from Step 7 and stored context configuration. The server combines these data into a structured record including fields for image data and context fields. The output is a frame context record used by subsequent modules.

### Step 9:

The server selects a prompt template based on user role and context.
The server examines the frame context record to determine the user role and usage situation. The input is the context record from Step 8 and a library of predefined prompt templates. The server executes a selection algorithm that maps combinations of role and situation to a specific template (for example, “visually impaired-outdoor” or “security guard-night patrol”). The output is a selected template containing static text with placeholders for dynamic fields.

### Step 10:

The server generates a concrete prompt sentence.
The server fills the template placeholders with dynamic information such as environment type, urgency level, or recent scene changes. The input is the selected template from Step 9 and dynamic values derived from recent frames (for example, motion level or last detected hazard). The server performs string operations to concatenate static and dynamic segments into a single natural-language prompt sentence. The output is a fully formed prompt sentence, such as:
“You are assisting a visually impaired person who is walking outdoors. Analyze this image and describe any potential danger, such as obstacles, moving vehicles, bicycles, uneven ground, or steps. Provide a short summary of the scene and a clear instruction on what the user should do next.”

### Step 11:

The server packages the image and prompt for the generative AI model.
The server converts the normalized image tensor into an encoded format required by the model interface (for example, base64-encoded JPEG bytes) and constructs a request object containing the prompt sentence, the encoded image, and inference parameters. The input is the prompt sentence from Step 10 and the normalized image tensor from Step 7. The server performs data serialization and parameter setting, such as specifying maximum output length or response style. The output is a structured request ready to be sent to the information analysis apparatus.

### Step 12:

The server transmits the request to the information analysis apparatus.
The server uses a network client module to send the structured request over a secure channel to the apparatus hosting the generative AI model. The input is the request object from Step 11. The server encapsulates the request into a network message (for example, an HTTPS request) and sends it via the network interface. The output is a transmitted request and a pending state in which the server awaits a response.

### Step 13:

The server receives the analysis result information.
The server listens for the response from the information analysis apparatus and, upon arrival, reads and parses the response. The input is the network response containing model output data. The server performs deserialization (for example, JSON parsing) to extract text fields such as a scene description, detected hazards, and recommended actions. The output is an internal analysis result object with clearly separated components.

### Step 14:

The server interprets and filters the analysis results.
The server examines the analysis result object to determine hazard level and relevance. The input is the analysis result from Step 13. The server applies rule-based processing, such as matching keywords (for example, “obstacle ahead,” “suspicious person,” “no immediate danger”) and computing a hazard score. The server may also compare the current result with previous results to smooth fluctuations. The output is a hazard evaluation record including a score, category (for example, “high risk” or “safe”), and textual fragments to be used in guidance.

### Step 15:

The server generates a concise description text.
The server transforms the potentially long and detailed analysis description into a short, user-tailored message. The input is the hazard evaluation record from Step 14 and the original descriptive text from the model. The server applies summarization rules: selecting only the most critical objects or dangers, discarding redundant details, and formatting an instruction.
The output is a concise description text, such as:
“A bicycle is blocking the sidewalk about two meters ahead. Please slow down and move slightly to the right.”

### Step 16:

The server adjusts the message according to urgency and user role.
The server modifies wording, tone, and emphasis depending on hazard level and user role. The input is the concise description from Step 15 and the hazard score. The server may prepend alert phrases (for example, “Warning,” “Caution”) or simplify language for certain user profiles. The output is a finalized guidance text tailored to the current user and situation.

### Step 17:

The server converts the guidance text into audio data.
The server supplies the finalized guidance text to the text-to-speech engine. The input is the guidance text from Step 16. The server configures parameters such as voice type, speaking rate, and volume based on hazard level and environment noise assumptions. The text-to-speech engine performs digital signal processing to synthesize speech waveforms. The output is digital audio data in a specific format (for example, PCM or compressed audio) stored in a transmission buffer.

### Step 18:

The server transmits audio data to the terminal.
The server sends the synthesized audio data to the terminal over the existing communication session. The input is the audio buffer from Step 17 and the established connection parameters. The server segments the audio into packets, adds headers containing sequence numbers and timestamps, and transmits them via the network interface. The output is a stream of audio packets received by the terminal.

### Step 19:

The terminal receives and plays back the audio.
The terminal reads incoming audio packets, reconstructs the continuous audio stream, and feeds it to the audio output device. The input is the audio packet stream from the server. The terminal performs buffering, decoding if necessary, and digital-to-analog conversion using its audio hardware. The output is an acoustic signal emitted by the earphone, speaker, or bone-conduction device.

### Step 20:

The user listens to the guidance and adapts behavior.
The user hears the spoken guidance message in near real time. The input is the acoustic signal produced in Step 19 and the user's current perception and movement. The user interprets the guidance (for example, instruction to stop, turn, or proceed) and physically changes walking speed, direction, or vigilance. The output is a modified user trajectory or behavior that reflects the hazard notification.

### Step 21:

The server updates temporal context and prepares for the next iteration.
The server logs the hazard evaluation, guidance text, and timestamp, and updates temporal state such as last hazard category and recent motion level. The input is the processed analysis result and the system clock. The server stores these values in a history buffer and uses them to influence future prompt sentences and processing frequency. The output is an updated context state that enables continuous, context-aware monitoring in the next cycle.
It is also possible to incorporate an emotion engine for estimating the user's emotions. That is, the specific processing unit 290 may estimate the user's emotions using an emotion identification model 59, and perform specific processing based on the estimated emotions.

### Example 2

Description follows regarding a flow of the specific processing in an Example 2. The units of the system described below are implemented by the data processing device 12 and the smart device 14. The data processing device 12 is called a “server” and the smart device 14 is called a “terminal”.

Conventional computer-implemented navigation support systems for visually impaired users typically rely on fixed rule sets or simple classification outputs derived from sensor data. In many such systems, an image processing module detects objects or obstacles, and a separate module converts these detections into preset audio messages. This architecture suffers from several technical limitations. First, the mapping from low-level detections to user-facing instructions is often hard-coded and inflexible, which leads to either oversimplified or overly verbose guidance that does not adapt well to rapidly changing environments. Second, because the guidance generation logic is tightly coupled to specific detection outputs, the system becomes difficult to maintain and extend; changes to perception models require manual re-engineering of the instruction logic. Third, naive combinations of computer vision outputs and generic language generation can produce instructions that are inconsistent with the actual scene, or that suggest unsafe actions, thereby degrading reliability and user trust.

Furthermore, existing systems generally do not treat the construction of input to a generative AI model as a first-class computational problem. Unstructured or poorly constrained inputs to the generative AI model tend to produce non-deterministic and sometimes unsafe instructions. From a computer-technology perspective, the lack of an intermediate structured representation and the absence of a safety-aware feedback loop between perception and generation result in inefficient use of computing resources, unstable behavior under noisy sensor inputs, and difficulty in scaling the system to diverse environments. There is a need for a technical architecture that systematically transforms sensor data into structured environment information, dynamically constructs constrained prompt sentences for a generative AI model, and enforces consistency and safety through machine-verifiable checks, thereby improving the overall robustness, efficiency, and predictability of the computer system.

Accordingly, there is a demand for an improved computer system that: (i) converts raw image information into a structured environment representation suitable for machine reasoning; (ii) dynamically generates prompt sentences for a generative AI model based on that representation and user state; and (iii) programmatically validates and, if necessary, regenerates movement assistance instructions before converting them into audio output. Such a system should enhance the technical performance of the underlying computing platform by stabilizing the generation of guidance instructions, reducing erroneous or unsafe outputs, and enabling efficient, real-time execution on general-purpose hardware.

The specific processing by the specific processing unit 290 of the data processing device 12 in Example 2 is realized by the following means.

The present invention provides a server comprising a processor configured to control an image acquisition device to capture surrounding environments of a user and to generate time-series image information, to transmit the image information via a communication device, to execute an image processing program using a machine learning model so as to extract structured environment information including passage regions, obstacle regions, moving-object regions, and corresponding relative positional relationships and distance information, to dynamically construct a prompt sentence for a generative information processing model based on the structured environment information and a movement state of the user, to cause the generative information processing model to generate a movement assistance instruction text from the prompt sentence, to verify consistency and safety of the movement assistance instruction text with respect to the structured environment information and to modify or regenerate at least one of the prompt sentence and the movement assistance instruction text when the verification fails, and to control a voice generation device so as to convert the verified movement assistance instruction text into acoustic information for output to the user. This enables a computer-implemented navigation support architecture in which perception, prompt construction, generative inference, and safety validation are integrated into a closed-loop process, thereby improving computing system reliability, enabling stable and efficient real-time generation of context-appropriate guidance instructions, and reducing unsafe or inconsistent outputs compared with conventional rule-based or unconstrained generative approaches.

The term “processor” refers to a hardware or virtual computation unit, such as a central processing unit or a graphics processing unit, that executes instructions of one or more programs to perform information processing operations described in this specification.

The term “image acquisition device” refers to a hardware sensor, such as a camera or an imaging module, that captures visual information of a surrounding environment and outputs the visual information as image data.

The term “surrounding environments of a user” refers to physical spaces located within a sensing range of the image acquisition device worn or carried by the user, including structures, objects, and pathways that may affect user movement.

The term “time-series image information” refers to a sequence of image data elements, each associated with a capture time, that collectively represent temporal changes in a scene over a period.

The term “communication device” refers to a hardware or software communication interface, such as a wired or wireless transceiver, that transmits and receives data between the processor and one or more external devices or systems.

The term “information processing device” refers to a computing apparatus, which may be local or remote relative to the image acquisition device, that executes software programs to analyze, transform, or otherwise process data.

The term “image processing program” refers to executable instructions that, when executed by the processor, perform operations on image information, including but not limited to preprocessing, feature extraction, and analysis.

The term “machine learning model” refers to a trained computational model, such as a neural network or other statistical model, that receives input data and outputs analysis results based on parameters learned from training data.

The term “structured environment information” refers to data representing a scene in a predefined format, including labels, coordinates, distances, and relationships among regions or objects, suitable for programmatic reasoning and further processing.

The term “walking route” refers to a path or region along which the user can safely move, determined based on positions of obstacles, passage areas, and moving objects in the environment.

The term “passage region” refers to an area in the environment that is determined to be traversable by the user without collision, such as a sidewalk or walkway.

The term “obstacle region” refers to an area in the environment that is associated with an object or condition that may impede or endanger user movement, such as a barrier, post, vehicle, or other blockage.

The term “moving-object region” refers to an area that corresponds to an object that changes position over time, such as a pedestrian, bicycle, or vehicle, and that may interact with the user's movement path.

The term “relative positional relationships” refers to information indicating how passage regions, obstacle regions, and moving-object regions are located with respect to each other and with respect to the user, including relative directions and spatial ordering.

The term “distance information” refers to quantitative or qualitative values indicating separation between the user and regions or objects in the environment, such as numerical distances or distance ranges.

The term “movement state of the user” refers to information indicating the current or predicted motion of the user, such as whether the user is standing, walking straight, turning, or approaching a specific landmark or intersection.

The term “generative information processing model” refers to a computational model, such as a generative AI model or language model, that generates new data, including text, in response to input data and constraints.

The term “prompt sentence” refers to a text sequence or set of textual instructions provided as input to the generative information processing model, the text sequence specifying context, constraints, or desired output characteristics.

The term “movement assistance instruction text” refers to a text output generated by the generative information processing model, the text output describing guidance or instructions for the user's movement in natural language.

The term “consistency” refers to a condition in which the content of the movement assistance instruction text does not contradict and is logically compatible with the structured environment information.

The term “safety requirements” refers to predefined conditions or rules indicating that the movement assistance instruction text should not instruct actions that are likely to cause harm, collision, or unsafe behavior for the user.

The term “modify or regenerate” refers to processing that alters an existing prompt sentence or movement assistance instruction text, or creates a new one, in response to a determination that a verification condition is not satisfied.

The term “voice generation device” refers to a hardware or software component, such as a text-to-speech engine, that converts text data into acoustic information representing speech.

The term “acoustic information” refers to data representing audio waveforms or encoded audio signals that can be reproduced as sound by an audio output device.

The term “output device” refers to a hardware component, such as an earphone, speaker, or headset, that converts acoustic information into audible sound perceivable by the user.

In one embodiment, a server, a terminal, and a user cooperate to implement a navigation support system for visually impaired users. The server executes multiple software modules on one or more hardware processors, and the terminal provides sensing and audio output interfaces that interact with the user in real space. The system is configured not merely to automate human reasoning, but to improve computer-based perception, instruction generation, and safety validation through specific data structures, neural network architectures, and algorithmic flows, thereby enhancing processing speed, accuracy, and stability compared to conventional computer systems.

The server operates on a general-purpose computing platform that may include a central processing unit, a graphics processing unit, a volatile memory, a non-volatile storage device, and a network interface. The server executes an operating system such as a general-purpose server operating system, and an application stack including an image processing library (for example, a library such as OpenCV), a machine learning framework (for example, a framework such as TensorFlow or an equivalent deep learning framework), and a text-to-speech client library for accessing a network-based speech synthesis service. The server further executes a generative AI model, implemented as a large-scale neural network (for example, a transformer-type language model) that runs locally or through a model-serving interface.

The terminal operates as a mobile computing device such as a smartphone or a dedicated wearable controller. The terminal includes a communication module (for example, a cellular, wireless local area network, or short-range wireless communication module), an audio interface, and an interface to a camera mounted on smart glasses worn by the user. The terminal relays camera image data and receives audio signals to be played to the user. In some embodiments, the terminal executes lightweight preprocessing steps, whereas the server performs the computationally intensive operations.

The user wears smart glasses that incorporate an image acquisition device in the form of a digital camera module. The user also wears an audio output device such as an earphone or headset coupled to the terminal. By moving in a real-world environment (for example, a sidewalk, a crosswalk, or an indoor corridor), the user causes the smart glasses to capture time-series image information representing the surroundings. This physical motion changes incoming sensor inputs, and the server's processing loop continuously updates its guidance output to reflect the current environment.

The server uses the image acquisition device to obtain time-series image information. The camera may capture images at a rate of, for example, 10 to 30 frames per second with a resolution such as 640×480 pixels or higher. The server receives the frames via the terminal through a communication device, such as a wireless protocol stack including a transport layer (for example, Transmission Control Protocol) and an application layer (for example, Hypertext Transfer Protocol or a streaming protocol). The server stores incoming frames in a ring buffer in memory to hold a configurable number of most recent frames. Each frame is associated with metadata including a timestamp, camera orientation parameters, and a user identifier.

The server uses an image processing program, implemented as a software module in the machine learning framework, to preprocess the frames. The server resizes frames, converts color space, normalizes pixel values, and applies denoising filters using library functions such as Gaussian blur, histogram equalization, or color normalization. The server represents each frame as a multi-dimensional array (for example, a tensor of shape corresponding to height, width, and channels) and transfers these tensors to the graphics processing unit to accelerate subsequent neural network inference. This preprocessing reduces computation load and stabilizes inputs to downstream models, improving both processing speed and recognition robustness.

The server uses a machine learning model to analyze the preprocessed frames and generate structured environment information. In one embodiment, the server uses a convolutional neural network-based object detection model, such as a model of the single-shot detection type or region-based detection type, implemented in the machine learning framework. The model receives a preprocessed frame as input and outputs a set of bounding boxes, class labels, and confidence scores. The server uses a non-maximum suppression algorithm to merge overlapping detections based on the confidence scores and intersection-over-union thresholds. The server then obtains labeled objects such as sidewalk edges, obstacles (for example, poles, trash cans, construction barriers), moving objects (for example, pedestrians, bicycles), and fixed structures (for example, walls, buildings).

In addition, the server uses a semantic segmentation model such as an encoder-decoder-style convolutional neural network or a transformer-based segmentation network. The server feeds the same frame to the segmentation model, which outputs a pixel-wise label map. The label map assigns a class (for example, passage region, roadway region, building region, vegetation region) to each pixel. The server combines the object detector outputs and the segmentation outputs using a data fusion module. This module groups pixels and objects into higher-level regions such as a contiguous passage region or a contiguous obstacle region, and computes relative positional relationships and distance information.

To compute distance information, the server may use camera calibration parameters and geometric relationships in a monocular setting, or may use depth information from stereo imaging or a depth sensor if available. The server may estimate distance via inverse perspective mapping, where pixels at certain vertical positions in the image are mapped to estimated distances on the ground plane, using known camera height and field-of-view parameters. The server encodes distances as numerical values (for example, in meters) and directions as angles or discrete categories (for example, left, center, right).

The server aggregates detection and segmentation results into structured environment information using a predefined data structure. The data structure may be a table or hierarchical object that includes fields such as region type, coordinates in a world-referenced coordinate system or user-centric coordinate system, distance, direction, and motion state. For example, a structured environment entry for a construction barrier may include: type =obstacle region; distance=9.0; direction=slightly left; width=1.0; height=1.2; motion state=static. The server may store multiple entries for passage regions, obstacle regions, and moving-object regions for each frame and may also maintain a temporal sequence of these entries to track changes over time.

The server performs temporal smoothing and tracking by associating object detections across frames with tracking identifiers using a tracking algorithm such as a Kalman filter-based tracker or a deep feature-based association method. By tracking objects and regions over time, the server filters out transient noise and reduces spurious detections, thereby stabilizing the structured environment information. This improves technical performance by reducing jitter in guidance and avoiding unnecessary or conflicting instructions.

The server uses the structuralized environment information, along with a movement state of the user, to build a prompt sentence for a generative AI model. The movement state may be derived from past positions of passage regions, user step count from other sensors, or an inertial measurement unit integrated with the terminal or smart glasses. The server classifies the movement state (for example, currently walking straight, turning, approaching intersection) using rule-based logic or a lightweight classifier. Then the server constructs a text sequence that describes the scene and states constraints for the desired instructions.

The server encodes the structured environment information into a scene description in natural language, but in a standardized format. For example, an internal description may be: “Clear sidewalk ahead for 12 meters; construction barrier at 9 meters, slightly left; safe passage available by moving 2 meters to the right; user walking forward at moderate speed.” The server then constructs a prompt sentence that includes not only the scene description but also explicit constraints on instruction length, style, and safety. For example, the server may generate the following prompt sentence:
“The user is visually impaired and is walking forward. Current environment: clear sidewalk for 12 meters ahead; construction barrier 9 meters ahead blocking the center; safe path available by moving about 2 meters to the right. Generate one or two short English sentences that politely instruct the user how to move safely, without mentioning technical terms.”

In another scenario, the server may construct a prompt sentence:
“The user is a visually impaired pedestrian wearing smart glasses. Current observations: a clear sidewalk extends 10 meters ahead, a street lamp post stands 5 meters ahead in the center of the sidewalk, and a bicycle is moving towards the user from behind on the left side at medium speed. Generate one short English instruction that tells the user exactly how to walk safely. Do not mention cameras, models, or technical terms. Use polite and direct language.”

By systematically converting numerical and symbolic environment data into constrained textual prompts, the server improves the determinism and controllability of the generative AI model, thereby reducing variability and unsafe outputs that would result from unstructured prompts.

The server uses a generative AI model implemented as a transformer-based neural network trained on large-scale text data and fine-tuned on navigation and instruction-style data. The model has a plurality of self-attention layers and feed-forward layers with parameters learned through supervised learning and possibly reinforcement learning from human feedback. During training, the server (or an offline training system) uses a loss function such as a cross-entropy loss over predicted tokens relative to ground-truth instruction texts. The training process updates network parameters via gradient descent and backpropagation. Training data include pairs of scene descriptions and safe, concise navigation instructions annotated by human experts. The training may incorporate safety labels, where instructions that violate rules (for example, instructing to “run” or “cross without checking”) are penalized or excluded.

The generative AI model, when deployed, receives the prompt sentence as an input token sequence and outputs a token sequence representing the movement assistance instruction text. The server configures generation parameters such as maximum token length, sampling temperature, and penalty for repetition to favor concise, stable outputs. The server may constrain the decoding process using a constrained decoding algorithm that limits instructions to specific grammatical patterns or prohibits certain phrases. This control over decoding behavior yields consistent instruction styles and reduces the need for downstream filtering.

The server performs a safety and consistency verification step. The server parses the generated movement assistance instruction text, using either a rule-based parser or a lightweight classifier, to extract the implied action (for example, go straight, turn right, stop, cross). The server then compares this implied action with the structured environment information. For example, if the instruction suggests moving straight ahead but a barrier exists in the direct path, the server detects a conflict. The server applies a set of safety requirements stored as rules or constraints, such as: “if crosswalk signal is not in safe state, do not instruct crossing,” “do not use verbs indicating running or rushing,” or “do not instruct movement toward an obstacle region at a distance less than a threshold.” If the server determines that the instruction violates any rule or conflicts with environment data, the server modifies the prompt sentence to include stricter safety constraints and regenerates the instruction. For instance, the server may augment the prompt sentence with: “Generate only safe walking instructions that never tell the user to run or to cross a road without a clear safe indication.” This closed-loop process between perception, prompt construction, generative inference, and rule-based verification improves system-level safety and robustness.

The server converts the verified movement assistance instruction text into acoustic information using a text-to-speech engine. The server may call a network-based speech synthesis service through a secure network protocol and specify language, voice quality, and speed parameters. The speech synthesis service runs its own neural network models (for example, sequence-to-sequence acoustic models and vocoders), which generate audio waveforms corresponding to the text. The server receives the audio as an encoded stream (for example, in a compressed audio format) and, optionally, modifies metadata or re-encodes the audio to match terminal capabilities. This audio conversion step translates textual computation results into a form directly consumable by the user, thus closing the loop from visual sensing to audible guidance.

The terminal receives the acoustic information from the server and controls the audio output device. The terminal decodes the audio stream using its multimedia framework and outputs the resulting audio signal through the earphone or headset. The terminal may adjust the playback volume in response to ambient noise levels detected by a built-in microphone or based on user preferences. The terminal may also manage concurrency of multiple instructions by queuing or interrupting previous audio segments, ensuring that the user hears the most relevant and recent guidance. This immediate feedback enables the user to adapt their walking direction, pause, or make small adjustments in position, which in turn changes the subsequent visual inputs.

The described architecture provides technical improvements beyond simple human task automation. Because the server uses specific deep neural architectures for detection, segmentation, and language generation, combined with structured environment representations, temporal smoothing, and rule-based safety checks, the server achieves higher accuracy in recognizing passage regions and obstacles, and generates instructions that are context-appropriate and safe with lower latency. The use of GPU acceleration and batched tensor operations improves processing speed for high-frame-rate image streams. The standardized structured environment information and prompt construction reduce the size and complexity of the data transmitted to the generative AI model, decreasing communication and computation overhead compared with passing raw images or unfiltered descriptions. The feedback loop between environment data and generated instructions reduces erroneous outputs, lowering the need for retransmissions or additional computations to correct mistakes.

The server employs algorithms that are not equivalent to the way humans would manually generate instructions. The server uses explicit numerical thresholds, vector-based region representations, and neural network-based feature extraction beyond human mental capabilities. For example, the server can evaluate hundreds of object candidates in each frame, track them over time via multi-target tracking, and integrate them with user motion data to construct fine-grained spatial models of the environment. The generative AI model uses parameter vectors with millions or billions of entries, exploiting high-dimensional feature spaces and attention mechanisms to tailor instructions. This computational processing differs fundamentally from human heuristics and yields measurable improvements in consistency and response time.

In another embodiment, the server executes the generative AI model locally using a specialized hardware accelerator (for example, an inference accelerator). This configuration further reduces network latency and allows high-frequency updates to instructions. In some variants, the terminal may perform a subset of detection operations locally using a compressed convolutional model to reduce uplink bandwidth usage, with the server performing more advanced analysis and generation steps. In further variants, the server maintains multiple machine learning models and selects between them based on context (for example, indoor vs. outdoor environments) to optimize accuracy and computational load.

In yet another embodiment, the server stores multiple templates for prompt sentences with different safety levels and verbosity levels. The server switches templates based on user preferences or system state, such as in a high-density traffic environment where shorter, more urgent instructions are prioritized. The server may also log structured environment information and instructions to a storage device for subsequent model retraining and performance analysis, thereby enabling continuous improvement of the system's technical performance.

By integrating camera control, image analysis, structured data construction, constrained prompt sentence generation, generative AI-based instruction production, safety verification, and text-to-speech conversion in a unified architecture, the server provides a concrete technical solution that transforms raw sensor inputs into reliable audio guidance. The system enhances the functioning of the computer itself by managing data flow, reducing noise and inconsistency, and using specialized models and algorithms to achieve low-latency and high-accuracy operation that could not be obtained with generic rule-based software or manual processes.

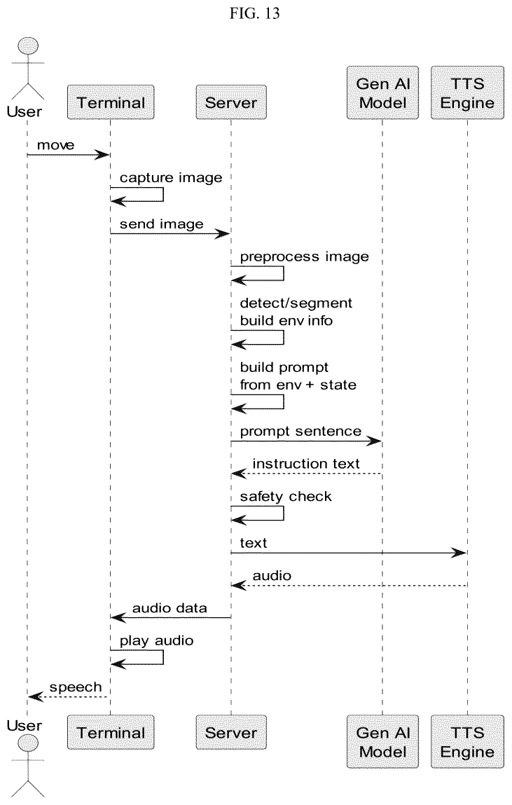

The following describes the processing flow using FIG. 13.

### Step 1:

The terminal acquires image data from the image acquisition device mounted on the smart glasses.
The terminal receives raw image frames as input from the camera sensor, which outputs pixel data in a format such as YUV or RGB at a frame rate of, for example, 10 to 30 frames per second.
The terminal performs minimal formatting of the data, such as encapsulating each frame together with a timestamp and a user/session identifier, and then transmits the encapsulated frames to the server via a wireless communication channel.
The terminal outputs a continuous stream of time-series image information as network packets addressed to the server.

### Step 2:

The server receives the time-series image information from the terminal via the communication device.
The server takes as input the network packets containing encoded image frames, timestamps, and identifiers.
The server decodes the packets, reconstructs individual frames, and stores them into a ring buffer in main memory, associating each frame with metadata such as capture time and frame index.
The server outputs normalized access to recent frames, for example, a reference to the N most recent frames ready for preprocessing.

### Step 3:

The server preprocesses each received frame to create a normalized image tensor suitable for machine learning inference.
The server uses the buffered frame as input and applies image processing operations, such as resizing to a fixed resolution, converting color space to RGB or BGR, and normalizing pixel intensity values into a floating-point range.
The server also applies noise reduction and contrast adjustment by executing functions from an image processing library, thereby reducing sensor noise and illumination variability.
The server outputs a preprocessed image tensor, for example, a three-dimensional array with dimensions corresponding to height, width, and color channels, which is then copied to graphics processing unit memory for subsequent analysis.

### Step 4:

The server performs object detection on the preprocessed image tensor to identify relevant entities in the environment.
The server uses the preprocessed tensor as input to a trained convolutional neural network-based detection model instantiated in a machine learning framework.
The server executes forward propagation of the neural network on the graphics processing unit, computing convolution, activation, and pooling operations layer by layer to produce feature maps and, finally, bounding box proposals with class scores.
The server applies non-maximum suppression and confidence thresholding to these proposals, thereby filtering overlapping and low-confidence detections and outputting a set of detected objects, each represented by a class label, a bounding box, and a confidence score.

### Step 5:

The server performs region segmentation on the same preprocessed image tensor to identify passage regions, obstacle regions, and other semantic areas.
The server uses the tensor as input to a semantic segmentation network, such as an encoder-decoder architecture, and executes the network on the graphics processing unit to compute per-pixel class probabilities.
The server assigns to each pixel a region label corresponding to the class with the highest probability and optionally applies morphological operations to smooth the segmentation map and remove small isolated regions.
The server outputs a label map in which each pixel is associated with a semantic class, such as passage, road, obstacle, or background.

### Step 6:

The server fuses the object detection results and the region segmentation results to construct structured environment information.
The server takes as input the set of detected objects, their bounding boxes, confidence scores, and the segmentation label map.
The server computes the intersection between object bounding boxes and labeled regions, classifies each object as belonging to a passage region, obstacle region, or moving-object region, and assigns additional attributes such as approximate width and height in real-world units.
The server outputs structured environment entries, for example, records specifying region type, bounding coordinates in image space, associated class labels, and initial qualitative direction (left, center, right) relative to the image center.

### Step 7:

The server estimates distances and relative directions of regions and objects to express the structured environment information in user-centric coordinates.
The server uses as input the fused environment entries, camera calibration parameters (for example, focal length, principal point, and camera height), and optional depth information if available.
The server computes for each entry an estimated distance by applying geometric mapping from image coordinates to ground-plane coordinates, for example, using inverse perspective mapping formulas, and determines the direction by comparing the horizontal position of the entry's centroid to the image center.
The server outputs updated structured environment entries containing numerical distance values, direction categories, and relative positional relationships, such as “in front,” “to the right,” or “behind.”

### Step 8:

The server tracks regions and objects over a short time window to stabilize the structured environment information.
The server uses as input the structured entries from multiple recent frames, each with associated timestamps.
The server applies a tracking algorithm, such as a Kalman filter or feature-based association, to assign persistent identifiers to regions and to update their estimated positions and velocities by combining predictions and new measurements.
The server outputs a temporally smoothed structured environment representation that reduces jitter and noise, including tracked passage regions, persistent obstacle regions, and moving-object regions with velocity estimates.

### Step 9:

The server determines a movement state of the user based on the temporal evolution of the structured environment and optional sensor data.
The server takes as input the temporally smoothed environment representation and, optionally, user motion data from inertial sensors or step counters available via the terminal.
The server applies rule-based logic or a lightweight classifier to infer states such as “standing still,” “walking straight,” “turning right,” or “approaching a crossing,” using thresholds on changes in passage region position and user displacement.
The server outputs a discrete movement state value that will serve as context for generating appropriate instructions.

### Step 10:

The server constructs an internal scene description string from the structured environment information and the movement state of the user.
The server uses as input the tracked and smoothed environment entries (including distances, directions, and types) and the discrete movement state.
The server selects only those entries that are relevant to near-term navigation, for example, obstacles and passage regions within a predetermined distance range, and formats them into a concise textual description, specifying object types, distances, and directions in a normalized manner.
The server outputs a scene description, such as “Clear sidewalk ahead for 12 meters; construction barrier 9 meters ahead blocking the center; safe space available 2 meters to the right; user walking forward.”

### Step 11:

The server generates a prompt sentence for a generative AI model using the scene description and predefined constraints.
The server uses as input the textual scene description and configuration parameters that define user attributes, desired instruction length, expression style, and safety constraints.
The server inserts the scene description and constraints into a prompt template and concatenates them into a single text sequence, thereby specifying explicit requirements for the generated instruction, such as avoiding technical terms and enforcing safety rules.
The server outputs a prompt sentence, for example: “The user is visually impaired and is walking forward. Current environment: clear sidewalk for 12 meters ahead; construction barrier 9 meters ahead blocking the center; safe path available by moving about 2 meters to the right. Generate one or two short English sentences that politely instruct the user how to move safely, without mentioning technical terms.”

### Step 12:

The server invokes the generative AI model to generate a movement assistance instruction text based on the prompt sentence.
The server uses the prompt sentence as input to a generative AI model implemented as a transformer-based neural network, and encodes the input as tokens that are processed by multiple self-attention and feed-forward layers.
The server performs inference by running the model on a processor or accelerator, computing probability distributions over output tokens at each step and selecting tokens according to a decoding strategy, such as greedy decoding or constrained sampling with a limited vocabulary.
The server outputs a natural language instruction text, such as “There is a barrier ahead in about nine meters. Please move about two meters to your right and continue walking straight along the sidewalk.”

### Step 13:

The server verifies safety and consistency of the generated movement assistance instruction text against the structured environment information.
The server uses as input the instruction text and the structured environment representation, including distances, directions, and region types.
The server parses the instruction text using pattern matching and/or a lightweight language understanding module to extract the implied actions, directions, and referenced distances, and compares these with the numerical values and categories in the environment representation using predefined rules and thresholds.
The server outputs either a validation result indicating that the instruction is consistent and safe, or a rejection result indicating that the instruction conflicts with the environment or violates safety requirements.

### Step 14:

The server regenerates or adjusts the instruction when the safety and consistency verification fails.
The server uses as input the rejection result, the original prompt sentence, and the environment representation.
The server modifies the prompt sentence by adding additional safety constraints or clarifications, such as instructing the generative AI model to avoid certain verbs or to explicitly instruct the user to stop in ambiguous cases, and then re-invokes the generative AI model as in Step 12.
The server outputs a revised movement assistance instruction text that passes the safety and consistency checks.

### Step 15:

The server converts the validated movement assistance instruction text into acoustic information using a voice generation device.
The server uses the validated text as input and calls a text-to-speech service or engine, specifying parameters such as language, voice type, and speaking rate.
The server transmits the text over a network protocol to the speech synthesis engine, which computes an acoustic representation using its own neural models (for example, an encoder-decoder acoustic model and a vocoder), and the server receives an audio stream encoded in a format suitable for playback.
The server outputs the synthesized audio data as a sequence of audio frames or as an audio file to be sent to the terminal.

### Step 16:

The terminal receives the synthesized audio data from the server and prepares it for playback.
The terminal takes as input the transmitted audio stream or file, decodes the compressed audio using its multimedia subsystem, and buffers the decoded audio samples.
The terminal manages a playback queue, ensuring that older instructions are interrupted or faded out when a new, higher-priority instruction is received, thereby preventing conflicting or outdated messages from being played.
The terminal outputs a ready-to-play audio buffer associated with the latest movement assistance instruction.

### Step 17:

The terminal plays back the audio to the user through an audio output device.
The terminal uses the ready-to-play audio buffer as input and drives a digital-to-analog converter and amplifier connected to the earphone or headset.
The terminal adjusts playback parameters such as volume and, if implemented, dynamic range compression based on device settings or ambient sound levels, and then initiates audio playback so that the user hears the instruction in near real time.
The terminal outputs audible speech that communicates the movement assistance instruction to the user.

### Step 18:

The user responds to the audio instruction and updates their movement in the real environment.
The user takes the audible guidance as input, cognitively interprets the instruction, and modifies walking behavior accordingly, for example by changing direction, slowing down, stopping, or moving laterally to avoid an obstacle.
The user's change in position and orientation leads to a change in the visual scene captured by the image acquisition device, which results in new image frames being sent to the server through the terminal as in Step 1.
The user outputs an updated physical trajectory, which becomes the basis for the next iteration of the sensing and processing cycle.

### Application Example 2

Description follows regarding a flow of the specific processing in an Application Example 2. The units of the system described below are implemented by the data processing device 12 and the smart device 14. The data processing device 12 is called a “server” and the smart device 14 is called a “terminal”.

Conventional assistive systems that convert image data into spoken guidance for visually impaired users or drivers typically rely on fixed, rule-based pipelines. In such systems, a processor detects objects in images, applies predefined mappings from objects to messages, and then performs text-to-speech conversion. This architecture suffers from several technical limitations. First, the processor cannot flexibly adapt the content or structure of the output message to complex, context-dependent visual situations, such as crowded urban environments, indoor facilities with dense signage, or rapidly changing road conditions. As a result, the system may output redundant, delayed, or overly verbose messages, thereby degrading usability and increasing cognitive load on the user.

Second, conventional systems generally treat the user as a passive endpoint and do not incorporate any real-time information about the user's emotional state. In particular, although the system may receive speech input from the user as commands, the system does not extract acoustic features from the user's speech to estimate an emotional state, and therefore cannot dynamically adjust the linguistic style, length, or urgency of guidance messages. In high-stress scenarios, such as emergency maneuvers in traffic or unexpected obstacles in unfamiliar environments, the mismatch between the user's emotional state and the system's neutral output can lead to confusion, slower reaction times, and reduced safety.

Third, typical generative models, when applied, are invoked in a static manner: they receive only raw image features or generic prompts that are not systematically derived from structured perception data and system operation modes. This leads to unstable or inconsistent outputs, as the generative model is not constrained or guided by a well-formed prompt that reflects detected targets, positions, risks, and route context. In addition, prior systems do not separate low-level perception (object detection) from high-level generative reasoning (contextual instruction generation) in a way that is explicitly parameterized by prompt sentences. Consequently, such systems cannot reliably generate concise, safety-oriented instructions in real time, especially under limited computational and communication resources.

Therefore, there is a need for a computer-implemented system and method that structurally integrate (i) conventional image processing and structured detection, (ii) prompt-based invocation of a generative AI model, and (iii) emotion-aware adaptation of both text content and audio output characteristics. Such a system should improve the technical functioning of the computer-based guidance pipeline by enabling the processor to dynamically generate and refine prompt sentences and guidance text data in response to both environmental context and user emotional state, thereby achieving more efficient, robust, and user-appropriate real-time guidance.

The specific processing by the specific processing unit 290 of the data processing device 12 in Application Example 2 is realized by the following means.

The present invention provides a server comprising a processor configured to control an image acquisition device to continuously capture a surrounding environment and generate visual data; to transmit the visual data via a communication device to an information processing device, convert the visual data into a predetermined format, and store the converted visual data; to execute an image processing program on the visual data to detect a plurality of targets and indicators and to generate structured data including target information; to dynamically generate, based on the structured data and an operation mode, a prompt sentence that instructs a generative learning model regarding an analysis content and an output format; to input the prompt sentence and the structured data into the generative learning model and to obtain a natural language analysis result regarding a surrounding situation; to generate guidance text data including a movement instruction or a warning, based on the analysis result and user attribute information, and to determine a message type according to an importance level; to control a speech synthesis device to convert the guidance text data into an audio signal and transmit the audio signal to an acoustic output device so that the audio signal is output to a user in real time; to acquire speech of the user, extract acoustic features from the speech, execute an emotion analysis model to estimate an emotional state of the user, and store the emotional state as session information; and to adjust at least one of a linguistic expression of the guidance text data and an audio output characteristic of the speech synthesis device according to the emotional state. This enables an improved computer-implemented guidance pipeline in which low-level perception and high-level generative reasoning are integrated through explicit prompt sentences and emotion-aware adaptation, thereby allowing the system to generate concise, context-appropriate, and user-tailored real-time audio instructions with reduced processing overhead and increased robustness in complex environments.

The term “processor” refers to a hardware computing element or a combination of hardware and executable instructions that performs arithmetic and logical operations, controls devices, and executes programmed functions of the system.

The term “image acquisition device” refers to a hardware component configured to capture visual information from a surrounding environment and to output the captured information as visual data, such as an imaging sensor, a camera module, or an equivalent optical sensing device.

The term “visual data” refers to digital data representing an image or a sequence of images of a physical environment, including but not limited to still image frames, video frames, or encoded image streams.

The term “communication device” refers to a hardware and software interface configured to transmit and receive data between the processor and an external device or network, including but not limited to wired interfaces and wireless interfaces.

The term “information processing device” refers to a computing apparatus or subsystem configured to receive, store, and process data according to instructions provided by the processor or associated software.

The term “predetermined format” refers to a specific data representation or encoding scheme defined in advance, such as a particular image resolution, color space, compression format, or data structure, suitable for subsequent processing by the system.

The term “image processing program” refers to executable instructions or software components that perform computational operations on visual data to derive higher-level information, such as filtering, feature extraction, object detection, or segmentation.

The term “targets” refers to objects, regions, or entities present in the visual data that are relevant to the system's analysis or guidance, including but not limited to obstacles, landmarks, signs, and other physical features.

The term “indicators” refers to visual elements in the visual data that convey information related to navigation, safety, or context, including but not limited to symbols, markings, text, pictograms, or graphical cues.

The term “structured data” refers to data that has been organized according to a defined schema or format, such as a record or hierarchical structure, and that includes explicit fields representing attributes of detected targets or indicators.

The term “target information” refers to data fields contained in the structured data that describe properties of detected targets, including but not limited to type, position, size, motion, and semantic category.

The term “operation mode” refers to a configuration state of the system that defines processing behavior, parameters, and priorities according to a particular use case, such as outdoor navigation, in-vehicle assistance, or indoor guidance.

The term “prompt sentence” refers to a textual instruction, query, or description generated by the processor and provided as input to a generative learning model to specify analysis objectives, output constraints, or contextual information.

The term “generative learning model” refers to a machine learning model configured to produce output data, such as natural language or other structured representations, from input data and a prompt sentence, including but not limited to generative neural network models.

The term “analysis content” refers to a specification of the type, scope, or subject of processing requested from the generative learning model, such as determining risks, summarizing surroundings, or generating navigation instructions.

The term “output format” refers to constraints or guidelines defining the structure, length, style, or representation of the output produced by the generative learning model.

The term “natural language analysis result” refers to a textual output generated by the generative learning model that describes, explains, or evaluates the surrounding situation in a human language.

The term “surrounding situation” refers to the physical conditions and spatial relationships present in the environment captured by the visual data, including the arrangement, movement, and properties of targets and indicators.

The term “guidance text data” refers to text generated by the processor that provides instructions, warnings, or explanations to a user based on the analysis result and other contextual information.

The term “movement instruction” refers to guidance text data that directs the user to perform a specific physical action or change in position, such as moving, turning, stopping, or avoiding an area.

The term “warning” refers to guidance text data that alerts the user to a potential or imminent risk, hazard, or unsafe condition in the surrounding situation.

The term “user attribute information” refers to data describing characteristics or preferences associated with a user, including but not limited to language preferences, accessibility needs, profile metadata, or historical interaction patterns.

The term “message type” refers to a classification of guidance text data according to its function or priority, such as an alert, instruction, or informational message.

The term “importance level” refers to a value or category indicating the relative urgency or criticality of guidance text data in relation to user safety or task performance.

The term “speech synthesis device” refers to a hardware and software component configured to convert text into an audio signal representing spoken language.

The term “audio signal” refers to a digital or analog representation of sound suitable for playback by an acoustic output device, including waveforms or encoded audio streams.

The term “acoustic output device” refers to a hardware component configured to convert an audio signal into audible sound perceivable by a user, such as a speaker, headset, or earphone.

The term “session information” refers to data maintained over a period of user interaction that stores context, state, or history, including at least the estimated emotional state of the user.

The term “acoustic features” refers to measurable properties derived from audio data, including but not limited to pitch, intensity, spectral characteristics, and temporal patterns.

The term “emotion analysis model” refers to a machine learning model configured to estimate an emotional state of a user based on acoustic features or other input signals.

The term “emotional state” refers to a classification or representation of a user's affective condition, such as calm, stressed, angry, sad, or similar categories, inferred by the emotion analysis model.

The term “linguistic expression” refers to the wording, phrasing, style, or structure of guidance text data as presented in natural language.

The term “audio output characteristic” refers to a parameter of the audio signal or speech synthesis, including but not limited to volume, pitch, speaking rate, timbre, or prosody.

In one embodiment, a server cooperates with a terminal and a user to provide context-aware, emotion-adaptive audio guidance based on visual information captured from a real environment. The system is implemented as a combination of dedicated hardware devices and software modules executed by a processor. The server executes an operating system such as a general-purpose server operating system, a runtime environment such as a virtual machine or container engine, and a plurality of application modules including an image processing module, a perception module, a generative AI interface module, a guidance generation module, a speech synthesis control module, and an emotion analysis module. The terminal includes an image acquisition device such as a digital camera mounted on smart glasses, a microphone, an acoustic output device such as earphones or speakers, a wireless communication interface, and a lightweight control processor.

The server uses a camera on the terminal as the image acquisition device. The camera is, for example, a high-resolution RGB sensor connected via a serial camera interface. The terminal configures the camera to capture frames at a predetermined frame rate and resolution, and encodes the frames into a compressed format such as a video codec or compressed still images. The terminal transmits the compressed visual data to the server via a wireless interface such as a wireless local area network or a short-range wireless protocol. The server receives the compressed visual data through a communication device and decodes the data into an internal visual data structure stored in main memory.

The server prepares the visual data in a predetermined format using an image processing library such as an open-source computer vision library. The server converts each decoded frame into a fixed-size tensor representation, for example, a three-dimensional array of normalized pixel intensities of a predetermined width and height. The server performs operations including resizing, color space conversion, and per-channel normalization so that downstream machine learning models receive consistent input distributions. The server optionally applies temporal smoothing or noise reduction to improve robustness in low-light or motion-blur conditions.

The server executes an image processing program to detect targets and indicators in the visual data. In one embodiment, the server uses an object detection model implemented with a deep learning framework such as a tensor-based neural network library. The object detection model includes a convolutional backbone network, such as a residual network or a mobile-optimized network, that extracts feature maps from the input image tensor. The model further includes a detection head, such as a single-stage or multi-stage detection architecture, that outputs bounding boxes, class scores, and confidence values for a pre-defined set of object categories. These categories may include, for example, obstacles, pedestrians, vehicles, signs, stairs, doors, and store shelves.

The server constructs structured data from the detection results. The server organizes detected objects into records containing fields such as object type, bounding box coordinates, estimated distance, estimated movement direction, and risk level. The server estimates distance by applying geometry-based heuristics such as bounding box size versus known object size, or by fusing depth information when available. The server computes a risk level based on factors including distance threshold, relative speed, and object category. The server represents this structured data in an internal schema, for example as a collection of records or as a hierarchical data structure in main memory. The server further associates an operation mode, such as street navigation mode, in-vehicle assistance mode, or indoor store navigation mode, with the active session.

The server dynamically generates a prompt sentence for a generative AI model based on the structured data and the operation mode. The server does not simply forward raw detections; instead, the server composes a textual description that summarizes critical aspects of the environment and that constrains the behavior of the generative AI model. The server selects and orders the most relevant targets according to risk level and proximity, and then fills a prompt template. For example, when a vehicle is in highway mode and the structured data indicates many stopped vehicles ahead, the server generates a prompt sentence such as:
“From the following front camera situation, determine whether there is a traffic jam ahead and generate one short safety instruction for the driver: multiple vehicles are stopped within 100 meters in the same lane and the relative speed is low.”

When a visually impaired pedestrian is in a city street mode, and the structured data contains a pole three meters ahead and a clear path to the left, the server generates a prompt sentence such as:
“You are assisting a blind pedestrian. There is a pole 3 meters ahead in the center of the path, and there is a clear path 1 meter to the left. Generate a concise instruction telling the user how to avoid the pole.”

When a user is inside a store searching for a specific section, and the structured data includes a sign corresponding to that section, the server generates a prompt sentence such as:
“You are an in-store navigation guide. The user wants to reach the drinks section. The nearest sign for the drinks section is 5 meters ahead and slightly to the left. Generate a brief navigation instruction to guide the user there.”

The server inputs the prompt sentence and associated structured data into a generative AI model. In one embodiment, the generative AI model is a sequence-to-sequence neural network implemented with a framework such as a tensor-based deep learning library. The model may have a transformer architecture with a multi-head self-attention mechanism and positional encodings. The model receives, as input, a tokenized representation of the prompt sentence and optionally a compact representation of structured detection features. The encoder part of the model encodes the prompt tokens into contextual embeddings, and the decoder part generates output tokens representing a natural language analysis result.

The server trains the generative AI model in advance using supervised learning on datasets containing environment descriptions and corresponding guidance sentences. The server defines a loss function such as a cross-entropy loss between predicted tokens and reference tokens, and updates model weights by performing gradient-based optimization such as stochastic gradient descent or adaptive gradient methods. During training, the server applies regularization techniques including dropout and data augmentation on text variants to improve generalization. By training the model on many prompt and response pairs that include explicit instructions about length and style, the server ensures that, during inference, the generative AI model reliably follows prompt constraints and produces concise, safety-oriented outputs.

The server obtains a natural language analysis result from the generative AI model. The analysis result may describe the surrounding situation, summarize risks, and recommend an action. The server parses the result and may map key phrases back to structured guidance categories. The server then generates guidance text data that is specifically tailored to the user. The server incorporates user attribute information such as language preference, level of visual impairment, and familiarity with the environment, and adjusts the verbosity and terminology accordingly. The server assigns a message type, such as “warning” for high-risk conditions, “instruction” for navigation steps, or “information” for general descriptions, and marks the importance level.

The server controls a speech synthesis device to convert the guidance text data into an audio signal. The server uses a text-to-speech engine, which may be a cloud-based or on-premise synthesizer, that converts text into speech waveforms. The server specifies parameters such as language code, voice type, speaking rate, pitch, and volume. The server receives an audio signal, for example an encoded waveform, and forwards the signal to the terminal.

The terminal delivers the audio signal to the user via an acoustic output device. The terminal decodes the signal and drives earphones or speakers integrated into smart glasses or a wearable audio device. The user hears real-time spoken instructions describing obstacles, traffic conditions, or store routes.

The user interacts with the system verbally. The user may request assistance (for example, “Where is the drinks section?”), ask for repetition (for example, “Say that again.”), or express confusion or stress. The terminal captures the user's speech through the microphone and sends the audio data to the server. The server extracts acoustic features from the audio using a signal processing library, computing measures such as fundamental frequency, energy, spectral centroid, formant characteristics, and speaking rate.

The server executes an emotion analysis model to estimate the user's emotional state. In one embodiment, the emotion analysis model is a neural network with recurrent or transformer layers that processes sequences of acoustic feature vectors. The model outputs probabilities over emotion categories such as calm, stressed, angry, or sad. The server selects the most likely category, or a combination of categories, and stores this emotional state as part of session information.

The server adapts both the content and the acoustic characteristics of subsequent guidance messages according to the emotional state. When the server determines that the user is stressed or angry, the server restricts message length and avoids complex multi-step instructions. The server may generate a second prompt sentence that rephrases a neutral message into a more reassuring tone. For example, if the neutral message is “Walk 5 meters straight, then turn left to reach the drinks section,” the server may create a second prompt sentence such as: “The user is anxious. Rewrite this navigation instruction in a calm and reassuring tone: Walk 5 meters straight, then turn left to reach the drinks section.”

The server sends this second prompt sentence together with the neutral message to the generative AI model, which produces an emotion-adapted guidance text such as:
“Please walk straight for about 5 meters, then gently turn left. I will guide you to the drinks section.”

The server also modifies speech synthesis parameters by lowering the speaking rate and volume, and selecting a softer voice profile. When the server determines that the user is sad or discouraged, the server chooses a brighter tone and slightly faster pacing to provide encouragement. This joint adjustment of linguistic expression and audio output characteristic is not a simple user preference change; it is a real-time control of signal generation and machine reasoning based on quantitatively estimated emotional features.

The system improves computer technology in several ways. First, the server decouples low-level perception (convolutional object detection) from high-level generative reasoning (transformer-based instruction generation) and connects them via explicit prompt sentences and structured data. This allows the server to reduce the amount of data transmitted to the generative AI model and to constrain the model to relevant context, thereby reducing computation, improving inference stability, and lowering communication load. The prompt sentence is not a generic question; it encodes a compact, machine-generated summary keyed to the current mode and structured detections, which improves the model's ability to produce consistent, short, task-focused outputs.

Second, the server improves processing efficiency by selecting only the most critical detections according to risk and proximity and by embedding them into the prompt. By avoiding sending full-resolution images or dense detection maps to the generative AI model, the server reduces memory usage and accelerates processing. The structured data format allows the server to reuse previously computed detections for multiple prompt generations as the user moves, further improving throughput.

Third, the emotion analysis module introduces a feedback loop that changes both model prompts and speech synthesis parameters based on measured acoustic features. This is not a mere cosmetic change; it causes the computational pipeline to adjust instruction complexity, message segmentation, and speech pacing to reduce user confusion and reaction time. By attaching an emotion-derived condition to the second prompt sentence, the server causes the generative AI model to generate text with constrained tone, which leads to more predictable and safe user interactions.

Fourth, the training and operation of the generative AI model are designed to optimize technical performance. The model architecture, loss function, optimization algorithm, and data augmentation strategy are selected to reduce perplexity on prompt-conditioned outputs and to improve adherence to length and style constraints. The server may fine-tune the model using domain-specific corpora containing short, imperative navigation instructions, thereby improving guidance accuracy in noisy or cluttered scenes.

Fifth, the server organizes data flow through distinct modules and well-defined data structures. The server maintains separate buffers for visual data, structured detection data, prompt sentences, generative outputs, and acoustic features. This modular design allows the server to perform pipeline parallelism and to apply priority scheduling to urgent messages, thereby improving latency for critical warnings. For example, when the structured data indicates an imminent collision risk, the server skips non-essential generative processing and uses predefined emergency prompts to drive immediate speech synthesis, while normal guidance continues in the background.

In alternative embodiments, the server may employ different neural architectures for perception and generation. The object detection network may be replaced by a transformer-based vision encoder, a region-based detector, or a lightweight model for embedded deployment. The generative AI model may be a mixture-of-experts transformer or a recurrent network augmented with attention mechanisms. The emotion analysis model may incorporate additional inputs such as linguistic features from automatic speech recognition to refine emotional classification. The server may also adapt the structured data schema to include additional fields such as predicted user trajectory or map alignment information.

The terminal may vary in form factor and communication protocol. The terminal may be a smartphone connected to a wearable camera, a vehicle-mounted computing unit, or a dedicated navigation device. The communication channel between the terminal and the server may use different wireless standards or may be partially or fully local when the server is implemented on the terminal hardware.

The described embodiments do not merely automate human judgment; they create a novel computing pipeline in which structured perception outputs are transformed by prompt-controlled generative reasoning and emotion-aware audio control, yielding technical improvements in processing speed, robustness, efficiency, and user safety in complex, real-world environments.

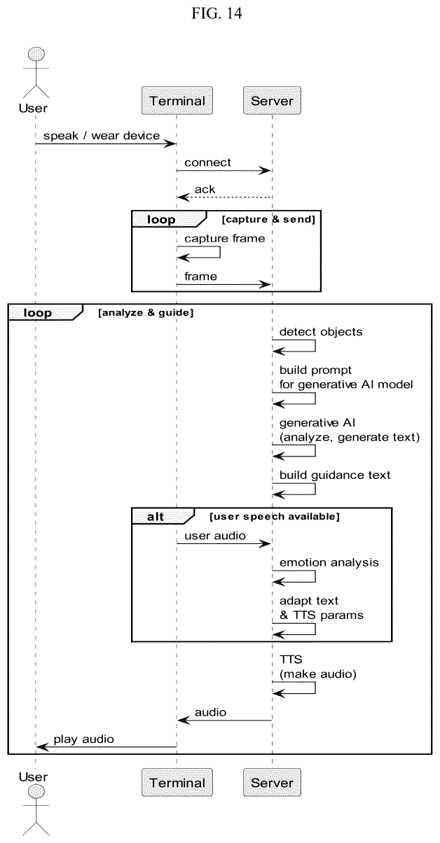

The following describes the processing flow using FIG. 14.

### Step 1:

Terminal initializes devices and connects to the server.
Terminal powers on an image acquisition device, a microphone, an acoustic output device, and a wireless communication interface.
Input: hardware status information and stored configuration parameters.
Terminal reads the configuration (frame rate, resolution, compression type, server address) from local storage, sets camera capture parameters via a device driver, and initializes audio and network stacks.
Output: an active camera stream configuration, an initialized audio path, and an established wireless session request sent toward the server.

### Step 2:

Server establishes a session and sets an operation mode.
Server accepts the connection request from the terminal, authenticates the terminal, and creates a session record including a unique session identifier, default operation mode, and user attribute information.
Input: terminal identification data, authentication tokens, and optional user profile data.
Server validates the authentication tokens, retrieves the user profile from persistent storage, and stores a session context containing language preference, default guidance verbosity, and initial operation mode (for example, “street navigation” or “indoor guidance”).
Output: a confirmed session with an assigned operation mode and a set of user attributes returned to the terminal as an acknowledgment.

### Step 3:

Terminal captures visual data continuously.
Terminal configures the camera into continuous capture mode and acquires a sequence of frames from the image acquisition device.
Input: camera configuration parameters (frame rate, resolution, exposure) and control commands from the terminal processor.
Terminal calls the camera driver to read raw image buffers, applies on-device adjustments such as exposure control if supported, and encodes the frames into compressed visual data (for example, compressed images or a video stream).
Output: a time-stamped series of compressed visual frames ready for transmission to the server.

### Step 4:

Terminal transmits visual data to the server.
Terminal packages each compressed frame into a network message with metadata and sends the messages to the server through the wireless communication interface.
Input: compressed frames and session metadata (session ID, timestamps, approximate device orientation if available).
Terminal constructs packets, attaches headers including session ID and timestamp, and transmits the packets using a transport protocol; when bandwidth is limited, terminal reduces frame rate or resolution prior to transmission.
Output: a sequence of network packets carrying visual data arriving at the server.

### Step 5:

Server receives and decodes visual data.
Server runs a receiver module that collects visual data packets from the communication device, reassembles them into complete frames, and decodes them into an internal image representation.
Input: network packets containing compressed visual frames and associated metadata.
Server verifies packet integrity, reorders packets if necessary using timestamps, decodes compressed data into raw image matrices, and stores each decoded frame and its metadata in a visual data buffer in main memory.
Output: a buffered sequence of decoded image tensors associated with session context and timestamps.

### Step 6:

Server preprocesses images for perception.
Server normalizes each decoded frame to a predetermined format suitable for subsequent neural network processing.
Input: raw image tensors and preprocessing parameters (target resolution, color space, normalization constants).
Server resizes each frame to a fixed width and height, converts the color space (for example, from device-specific format to RGB), scales pixel values to a normalized range, and optionally applies filters such as Gaussian blur reduction or contrast enhancement.
Output: preprocessed image tensors with standardized dimensions and value ranges stored in a perception input buffer.

### Step 7:

Server performs object and indicator detection.
Server executes an object detection model on the preprocessed image tensors to detect targets and indicators.
Input: preprocessed image tensors and model parameters (network weights, detection thresholds).
Server feeds each tensor into a deep neural network (for example, a convolutional backbone followed by a detection head), computes feature maps, predicts bounding boxes and class scores, filters results by confidence threshold, and groups detections into categories such as obstacles, landmarks, and signs.
Output: a detection list per frame containing object classes, bounding box coordinates, confidence scores, and preliminary risk tags.

### Step 8:

Server converts detections to structured data.
Server aggregates detection outputs into a structured representation associated with the current environment and operation mode.
Input: detection lists and session context including operation mode and user position estimate if available.
Server estimates distances from bounding box sizes or auxiliary depth data, calculates relative orientation angles, assigns a risk level based on distance thresholds and motion cues, and encapsulates this information into a structured data object such as records with fields for type, position, distance, motion state, and risk level.
Output: structured data describing key targets and indicators in the scene stored in an environment state buffer.

### Step 9:

Server selects salient information and summarizes environment context.
Server determines which targets are most relevant for guidance in the current frame.
Input: structured data and operation mode parameters (for example, maximum number of items, priority rules).
Server sorts targets by risk level and proximity, filters out low-importance items, and generates an internal textual summary describing only the most critical elements (for example, “pole 3 m ahead,” “vehicle queue 100 m ahead in same lane”).
Output: a concise environment description string and a pruned structured data set.

### Step 10:

Server generates a primary prompt sentence for the generative AI model.
Server composes a prompt sentence that encodes the environment description, the user's task, and constraints on the desired output.
Input: environment description, pruned structured data, operation mode, and user attribute information.
Server selects a prompt template appropriate for the operation mode (for example, driving assistance, street walking, store navigation), inserts textual variables such as distances and directions, and adds instructions about length and style, such as “one short sentence” or “concise safety instruction.”
Output: a primary prompt sentence, such as “You are assisting a blind pedestrian. There is a pole 3 meters ahead in the center of the path, and there is a clear path 1 meter to the left. Generate a concise instruction telling the user how to avoid the pole.”

### Step 11:

Server invokes the generative AI model to produce an analysis result.
Server provides the prompt sentence and optionally a compact representation of structured data to the generative AI model and obtains a natural language analysis of the situation.
Input: tokenized prompt sentence and optional detection-derived feature vectors.
Server maps the prompt sentence to tokens, feeds them to the encoder of a generative model (for example, a transformer-based sequence-to-sequence network), performs forward propagation through attention and feedforward layers, and decodes output tokens using constrained decoding (for example, beam search with length limits).
Output: a natural language analysis result such as “There is a pole 3 meters ahead. Please move one meter to your left to avoid it.”

### Step 12:

Server converts the analysis result into guidance text data.
Server maps the generative AI output into guidance text tailored to the user and categorized by message type.
Input: natural language analysis result, user attribute information, and risk level from structured data.
Server trims extraneous phrases, ensures that measurements follow user preference (for example, meters or feet), attaches a message type label such as “warning” or “instruction” based on risk, and stores the final wording and message type as guidance text data.
Output: labeled guidance text data ready for speech synthesis.

### Step 13:

Server acquires speech from the user for emotion analysis.
User speaks into the microphone, and the terminal transmits user speech data to the server.
Input: analog voice signal from the user and session metadata.
Terminal digitizes the voice signal, encodes it using an audio codec, and sends compressed audio packets to the server; server decodes the packets to reconstruct a digital audio waveform for analysis.
Output: a digital audio segment of user speech associated with the current session.

### Step 14:

Server extracts acoustic features and estimates the emotional state.
Server analyzes the user's speech to derive acoustic features and classify the emotional state.
Input: digital audio segment and preconfigured feature-extraction parameters.
Server computes features such as pitch contour, energy, spectral envelope, and speaking rate using a signal processing library, feeds a sequence of feature vectors into an emotion analysis model (for example, a recurrent or transformer-based neural network), and obtains probabilities for emotion categories such as calm, stressed, or angry.
Output: an estimated emotional state stored in the session context.

### Step 15:

Server generates a secondary prompt sentence for tone adaptation when needed.
Server decides whether to rephrase the guidance text based on the emotional state and message type, and if so, constructs a secondary prompt sentence describing tone requirements.
Input: guidance text data, message type, and estimated emotional state.
Server applies rules such as “if message type is warning and emotion is stressed, require calm and reassuring tone,” composes a secondary prompt sentence that includes the original guidance text and explicit tone instructions, such as “The user is anxious. Rewrite this navigation instruction in a calm and reassuring tone: Walk 5 meters straight, then turn left to reach the drinks section.”
Output: a secondary prompt sentence for emotion-adapted rephrasing.

### Step 16:

Server rephrases guidance text using the generative AI model.
Server invokes the generative AI model a second time to adapt the linguistic expression of the guidance text to the emotional state.
Input: secondary prompt sentence and original guidance text.
Server tokenizes the secondary prompt sentence, performs inference through the generative model in the same manner as in Step 11, but with tone constraints encoded in the prompt, and decodes the resulting tokens into a revised guidance sentence.
Output: emotion-adapted guidance text data, such as “Please walk straight for about 5 meters, then gently turn left. I will guide you to the drinks section.”

### Step 17:

Server configures text-to-speech parameters and synthesizes audio.
Server converts the final guidance text into an audio signal, taking into account both message type and emotional state.
Input: final guidance text data, message type, emotional state, and user attribute information.
Server selects text-to-speech parameters such as speaking rate, pitch, and volume (for example, slower and softer for stressed users, brighter for discouraged users), sends a synthesis request including the text and parameters to a speech synthesis engine, and receives an audio waveform or encoded audio stream in response.
Output: synthesized audio data representing the guidance message.

### Step 18:

Server transmits synthesized audio to the terminal.
Server prepares the synthesized audio for delivery and sends it through the existing communication channel.
Input: synthesized audio data and session metadata.
Server may apply normalization to keep loudness within a safe range, packetizes the audio stream with headers identifying message priority, and transmits packets to the terminal via the communication device.
Output: audio packets containing the guidance signal arriving at the terminal.

### Step 19:

Terminal outputs audio guidance to the user.
Terminal receives the audio packets, decodes them, and drives the acoustic output device to present the guidance to the user.
Input: audio packets and playback control parameters.
Terminal reassembles packets into a continuous audio stream, decodes the encoded waveform, optionally pauses or attenuates other audio sources, and sends the audio samples to earphones or speakers at the correct playback rate.
Output: audible guidance heard by the user, enabling the user to take an appropriate physical action such as slowing down, turning, or avoiding an obstacle.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Moreover, although the processing by the data processing system 10 described above was executed by the specific processing unit 290 of the data processing device 12 or by the control unit 46A of the smart device 14, the processing may be executed by a specific processing unit 290 of the data processing device 12 and a control unit 46A of the smart device 14. Moreover, the specific processing unit 290 of the data processing device 12 acquires and collects information needed for processing from the smart device 14 or from an external device or the like, and the smart device 14 acquires and collects information needed for processing from the data processing device 12 or from an external device or the like.

For example, a collection unit is implemented by the control unit 46A of the smart device 14 and/or by the specific processing unit 290 of the data processing device 12. For example, an acquisition unit acquires number-of-steps data using the camera 42 and/or the communication I/F 44 of the smart device 14, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the output device 40 of the smart device 14 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart device 14.

### Second Exemplary Embodiment

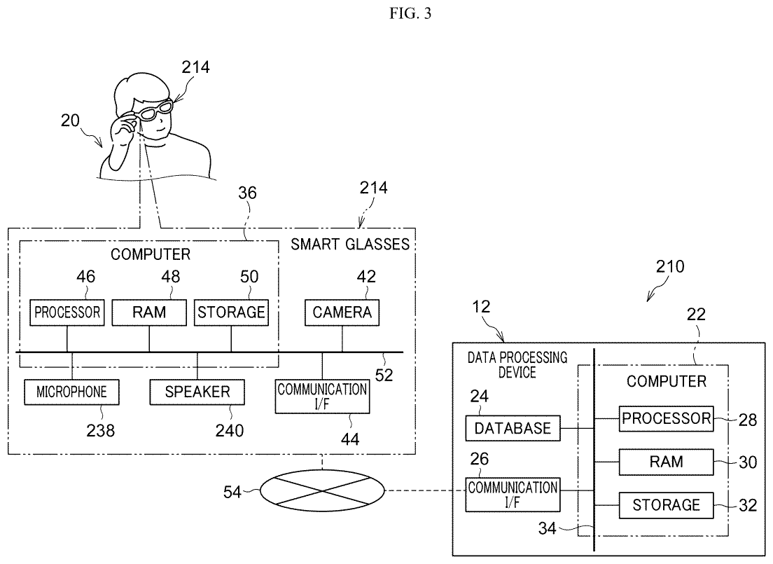

FIG. 3 illustrates an example of a configuration of a data processing system 210 according to a second exemplary embodiment.

As illustrated in FIG. 3, the data processing system 210 includes a data processing device 12 and smart glasses 214. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart glasses 214 include a computer 36, a microphone 238, a speaker 240, a camera 42, and a communication I/F 44. The computer 36 includes a processor 46, RAM 48, and storage 50. The processor 46, the RAM 48, and the storage 50 are connected to a bus 52. The microphone 238, the speaker 240, the camera 42, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

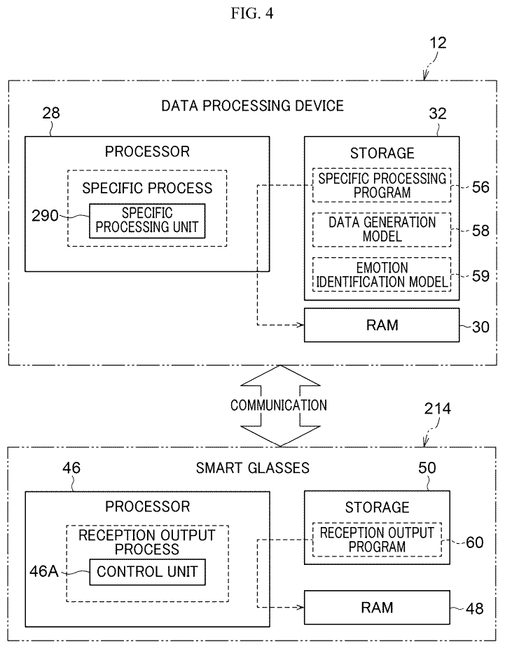

FIG. 4 illustrates an example of relevant functions of the data processing device 12 and the smart glasses 214. As illustrated in FIG. 4, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart glasses 214. A reception and output program 60 is stored in the storage 50. The processor 46 reads the reception and output program 60 from the storage 50 and in the RAM 48 executes the read reception and output program 60. The reception and output processing is implemented by the processor 46 operating as the control unit 46A according to the reception and output program 60 executed in the RAM 48. Note that a configuration may be adopted in which the smart glasses 214 include a data generation model and an emotion identification model similar to the data generation model 58 and the emotion identification model 59, and processing similar to the specific processing unit 290 is performed using these models.

Next, description follows regarding the specific processing by the specific processing unit 290 of the data processing device 12. The units of the system described below are implemented by the data processing device 12 and the smart glasses 214. In the following description the data processing device 12 is called a “server”, and the smart glasses 214 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the smart glasses 214. The control unit 46A in the smart glasses 214 outputs the specific processing result to the speaker 240. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the smart glasses 214, the processing may be executed by a specific processing unit 290 of the data processing device 12 and a control unit 46A of the smart glasses 214. Moreover, the specific processing unit 290 of the data processing device 12 acquires and collects information needed for processing from the smart glasses 214 or from an external device or the like, and the smart glasses 214 acquires and collects information needed for processing from the data processing device 12 or from an external device or the like.

For example, the collection unit is implemented by the control unit 46A of the smart glasses 214 and/or by the specific processing unit 290 of the data processing device 12. For example, an acquisition unit acquires number-of-steps data using the camera 42 and/or the communication I/F 44 of the smart glasses 214, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 of the smart glasses 214 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart glasses 214.

### Third Exemplary Embodiment

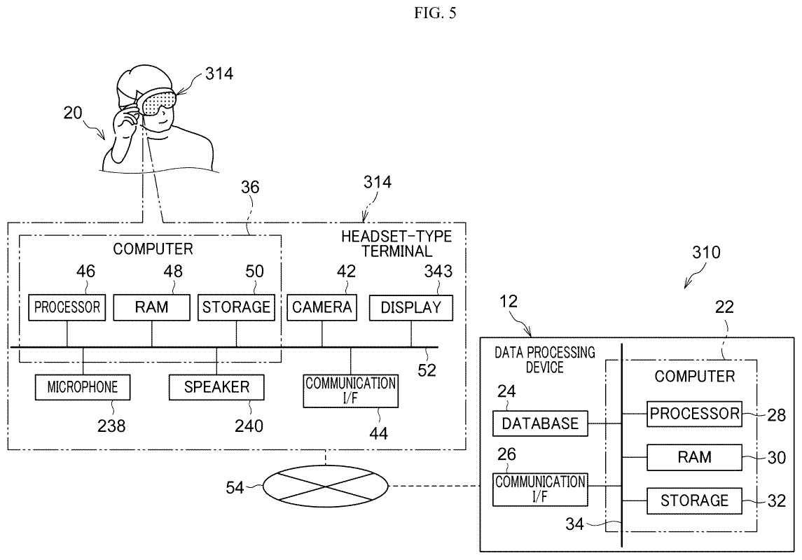

FIG. 5 illustrates an example of a configuration of a data processing system 310 according to a third exemplary embodiment.

As illustrated in FIG. 5, the data processing system 310 includes a data processing device 12 and a headset-type terminal 314. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The headset-type terminal 314 includes a computer 36, a microphone 238, a speaker 240, a camera 42, a communication I/F 44, and a display 343. The computer 36 includes a processor 46, RAM 48, and storage 50. The processor 46, the RAM 48, and the storage 50 are connected to a bus 52. The microphone 238, the speaker 240, the camera 42, the display 343, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

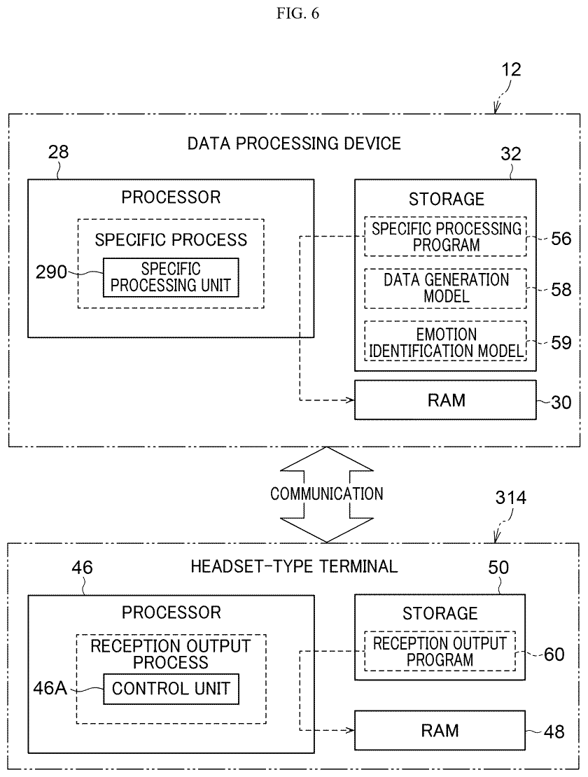

FIG. 6 illustrates an example of relevant functions of the data processing device 12 and the headset-type terminal 314. As illustrated in FIG. 6, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the headset-type terminal 314. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the headset-type terminal 314. In the following description the data processing device 12 is called a “server”, and the headset-type terminal 314 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the headset-type terminal 314. In the headset-type terminal 314, the control unit 46A outputs the result of the specific processing to the speaker 240 and the display 343. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the headset-type terminal 314, the processing may be executed by a specific processing unit 290 of the data processing device 12 and a control unit 46A of the headset-type terminal 314. Moreover, the specific processing unit 290 of the data processing device 12 acquires and collects information needed for processing from the headset-type terminal 314 or from an external device or the like, and the headset-type terminal 314 acquires and collects information needed for processing from the data processing device 12 or from an external device or the like.

For example, the collection unit is implemented by the control unit 46A of the headset-type terminal 314 and/or by the specific processing unit 290 of the data processing device 12. For example, an acquisition unit acquires number-of-steps data using the camera 42 and/or the communication I/F 44 of the headset-type terminal 314, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the display 343 of the headset-type terminal 314 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the headset-type terminal 314.

### Fourth Exemplary Embodiment

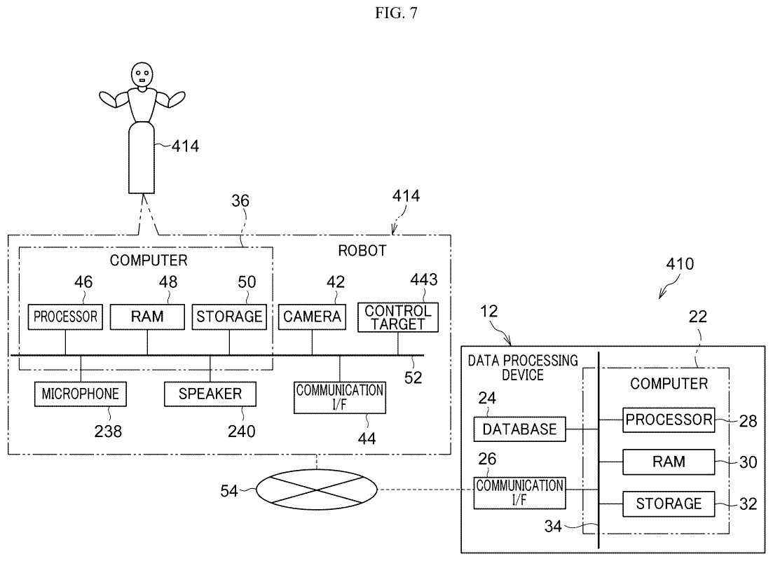

FIG. 7 illustrates an example of a configuration of a data processing system 410 according to a fourth exemplary embodiment

As illustrated in FIG. 7, the data processing system 410 includes a data processing device 12 and a robot 414. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The robot 414 includes a computer 36, a microphone 238, a speaker 240, a camera 42, a communication I/F 44, and a control target 443. The computer 36 includes a processor 46, RAM 48, and storage 50. The processor 46, the RAM 48, and the storage 50 are connected to a bus 52. The microphone 238, the speaker 240, the camera 42, the control target 443, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the robot 414 (for example, with an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

The control target 443 includes a display device, eye LEDs, and motors to drive arms, hands, feet, and the like. The posture and gesture of the robot 414 are controlled by controlling the motors of the arms, hands, feet, and the like. Part of an emotion of the robot 414 can be expressed by controlling these motors. Moreover, a facial expression of the robot 414 can be represented by controlling an illumination state of the eye LEDs of the robot 414.

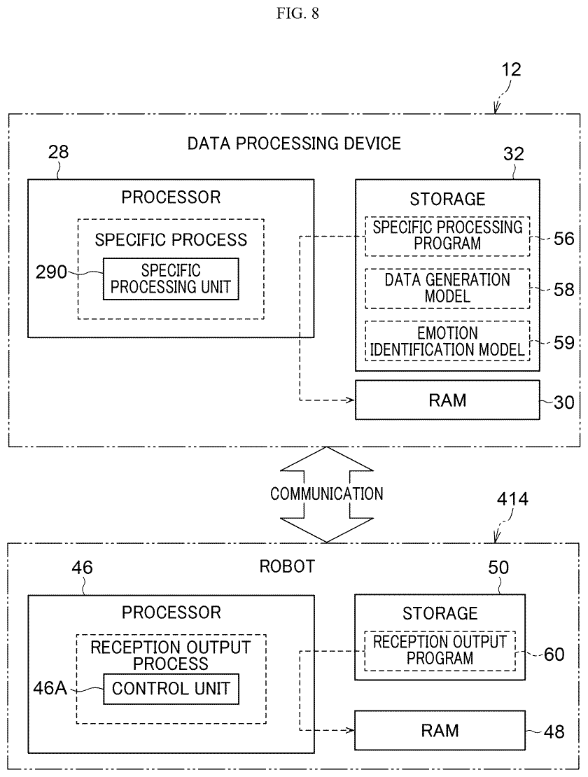

FIG. 8 illustrates an example of relevant functions of the data processing device 12 and the robot 414. As illustrated in FIG. 8, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the robot 414. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the robot 414. In the following description the data processing device 12 is called a “server”, and the robot 414 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the robot 414. In the robot 414, the control unit 46A outputs the result of the specific processing to the speaker 240 and the control target 443. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the robot 414, the processing may be executed by a specific processing unit 290 of the data processing device 12 and a control unit 46A of the robot 414. Moreover, the specific processing unit 290 of the data processing device 12 acquires and collects information needed for processing from the robot 414 or from an external device or the like, and the robot 414 acquires and collects information needed for processing from the data processing device 12 or from an external device or the like.

For example, the collection unit is implemented by the control unit 46A of the robot 414 and/or by the specific processing unit 290 of the data processing device 12. For example, an acquisition unit acquires number-of-steps data using the camera 42 and/or the communication I/F 44 of the robot 414, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the control target 443 of the robot 414 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the robot 414.

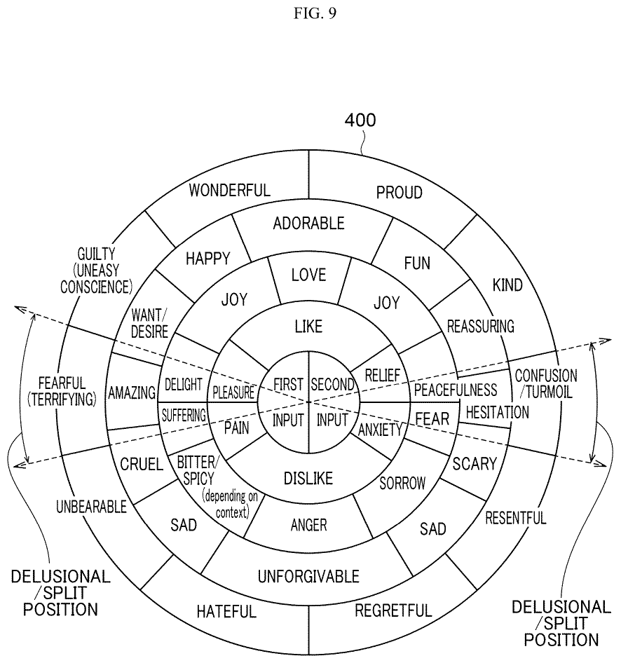

Note that the emotion identification model 59 serves as an emotion engine, and may decide the emotion of a user according to a specific mapping. Specifically, the emotion identification model 59 may decide the emotion of a user according to an emotion map (see FIG. 9) that is a specific mapping. Moreover, the emotion identification model 59 may also decide the emotion of the robot similarly, and the specific processing unit 290 may be configured so as to perform the specific processing using the emotion of the robot.

FIG. 9 is a diagram illustrating an emotion map 400 mapping plural emotions. In the emotion map 400, emotions are arranged in concentric circles that radiate out from the center. Primitive states of emotion are arranged nearer to the center of the concentric circles. Emotions expressing states and actions generated from states of mind are arranged further toward the outside of the concentric circles. Emotions are defined as including both affect and mental states. Emotions generated from reactions occurring in the brain are generally arranged at the left side of the concentric circles. Emotions induced by situational assessment are generally arranged at the right side of the concentric circles. Emotions generated from reactions occurring in the brain that are also emotions induced by situational assessment are generally arranged toward the top and toward the bottom of the concentric circles. Moreover, emotions of “euphoria” are arranged at the upper side of the concentric circles, and emotions of “dysphoria” are arranged at the lower side of the concentric circles. Plural emotions are accordingly mapped in this manner in the emotion map 400 based on a structure giving rise to emotions, and emotions that readily occur at the same time are mapped close to each other.

An example of such emotions is a distribution of emotions in the direction of 3 o'clock on the emotion map 400, generally around a boundary between relief and anxiety. Situational awareness dominates over internal sensations in the right half of the emotion map 400, with an impression of calm.

The inside of the emotion map 400 represents feelings, and the outside of the emotion map 400 represents actions, and so emotions further toward the outside of the emotion map 400 are more visible (are expressed by actions).

Human emotions are based on various balances, such as posture and blood sugar value balances, with a state of dysphoria being exhibited when these balances are far from ideal and a state of euphoria being exhibited when these balances are near to ideal. Even in a robot, a car, a motorbike, or the like, emotions can be thought of as being based on various balances such as orientation and remaining battery balances, with a state called dysphoria being exhibited when these balances are far from ideal and a state called euphoria being exhibited when these balances are near to ideal. An emotion map may, for example, be generated based on the emotion map of Dr. Mitsuyoshi (PhD Dissertation https://ci.nii.ac.jp/naid/500000375379: “Research on the phonetic recognition of feelings and a system for emotional physiological brain signal analysis”, Tokushima University). Emotions belonging to an area called “reaction” where feeling dominates are arranged in the left half of the emotion map. Moreover, emotions belonging to an area called “situation” where situational awareness dominates are arranged in the right half of the emotion map.

There are two types of emotion that facilitate leaning in an emotion map. One is an emotion in the vicinity of the center of negative “penitence” and “reflection” on the situational side. In other words, sometimes a negative “emotion” such as “I don't want to feel this way ever again” and “I don't want to be chided again” is experienced in a robot. Another is a positive emotion in the area of “desire” on the reaction side. In other words, there are times when a positive feeling such as “desire more” and “want to know more” is experienced.

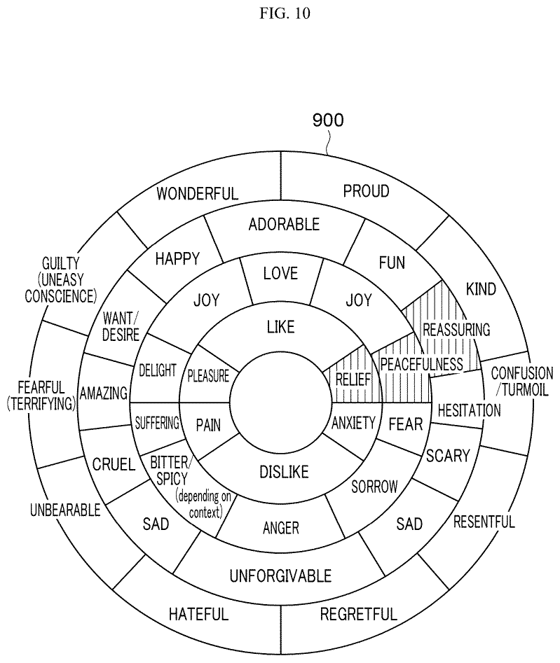

In the emotion identification model 59, user input is input to a pre-trained neural network, and emotion values indicating emotions shown on the emotion map 400 are acquired and the emotions of the user are decided. This neural network is pre-trained based on plural training data sets that each combine a user input with an emotion value indicating an emotion shown on the emotion map 400. The neural network is also trained such that emotions arranged close to each other have values that are close to each other, as in an emotion map 900 illustrated in FIG. 10. In FIG. 10 the plural emotions of “relief”, “peaceful”, and “reassured” are indicated as an example of close emotion values.

Although the system according to the present disclosure has been described mainly as functions of the data processing device 12, the system according to the present disclosure is not limited to being implemented in a server. The system according to the present disclosure may be implemented as a general information processing system. The present disclosure may, for example, be implemented by a software program operating on a personal computer, and may be implemented by an application operating on a smartphone or the like. The method according to the present disclosure may also be supplied to a user in the form of Software as a Service (SaaS).

Although in the exemplary embodiments described above examples are given of embodiments in which the specific processing is performed by a single computer 22, technology disclosed herein is not limited thereto, and distributed processing may be performed for the specific processing, with the specific processing distributed across plural computers including the computer 22. For example, the data generation model 58 may be provided in a device external to the data processing device 12, such that data generation in response to input data is performed in the external device.

Although in the exemplary embodiments described above examples are described of embodiments in which the specific processing program 56 is stored in the storage 32, the technology disclosed herein is not limited thereto. For example, the specific processing program 56 may be stored on a portable, non-transitory, computer readable, storage medium, such as universal serial bus (USB) memory or the like. The specific processing program 56 stored on the non-transitory storage medium is then installed on the computer 22 of the data processing device 12. The processor 28 then executes the specific processing according to the specific processing program 56.

Moreover, the specific processing program 56 may be stored on a storage device, such as a server connected to the data processing device 12 over the network 54, with the specific processing program 56 then being downloaded in response to a request from the data processing device 12 and installed on the computer 22.

Note that there is no need to store the entire specific processing program 56 on the storage device, such as a server connected to the data processing device 12 over the network 54, or to store the entire specific processing program 56 on the storage 32, and part of the specific processing program 56 may be stored thereon.

Hardware resources for executing the specific processing may use various processors as listed below. Examples of processors include, for example, a CPU that is a general-purpose processor that functions as a hardware resource to execute the specific processing by executing software, namely a program. Moreover, the processor may, for example, be a dedicated electronic circuit that is a processor having a circuit configuration custom designed for executing the specific processing, such as a field-programmable gate array (FPGA), a programmable logic device (PLD), or an application specific integrated circuit (ASIC). Memory is inbuilt or connected to each of these processors, and the specific processing is executed by each of these processors using the memory.

The hardware resource that executes the specific processing may be configured from one of these various processors, or may be configured from a combination of two or more processors of the same or different type (for example, a combination of plural FPGAs, or a combination of a CPU and a FPGA). The hardware resource executing the specific processing may be a single processor.

Examples of configurations of a single processor include, firstly, a configuration of a single processor resulting from combining one or more CPU and software, in an embodiment in which this processor functions as the hardware resource for executing the specific processing. Secondly, as typified by a System-on-chip (SOC) or the like, there is also an embodiment that uses a processor realized by a single IC chip to function as an overall system including plural hardware resources for executing the specific processing. Adopting such an approach means that the specific processing is realized using one or more of the various processors described above as hardware resource.

Furthermore, more specifically, an electrical circuit that combines circuit elements such as semiconductor elements or the like may be employed as a hardware structure of these various processors. The specific processing is merely an example thereof. This means that obviously redundant steps may be omitted, new steps may be added, and the processing sequence may be swapped around within a range not departing from the spirit of the present disclosure.

The described content and drawing content illustrated above are a detailed description of parts according to the present disclosure, and are merely examples of the present disclosure. For example, description related to the above configuration, function, operation, and advantageous effects is a description related to examples of the configuration, function, operation, and advantageous effects of parts according to the present disclosure. This means that obviously redundant parts may be eliminated, new elements may be added, and switching around may be performed on the described content and drawing content illustrated above within a range not departing from the spirit of the present disclosure. Moreover, to avoid misunderstanding and to facilitate understanding of parts according to the present disclosure, description related to common knowledge in the art and the like not particularly needing description to enable implementation of the present disclosure is omitted in the described content and drawing content illustrated as described above.

All publications, patent applications and technical standards mentioned in the present specification are incorporated by reference in the present specification to the same extent as if each individual publication, patent application, or technical standard was specifically and individually indicated to be incorporated by reference.

Note that, regarding the above description, the following supplementary notes are further disclosed.

### Example 1

### (Supplementary 1)

A system comprising a processor,
wherein the processor is configured to control an image acquisition device so as to capture a surrounding situation in a time series and to generate image data having a predetermined spatial resolution and temporal resolution, to append imaging time information and position information to the image data, and to transmit the image data via a communication control device to an analysis information processing apparatus on a server side,
to cause the analysis information processing apparatus on the server side to convert the image data into numerical data by using preprocessing software and to normalize the numerical data into an input format adapted to a generative machine learning model, to cause the analysis information processing apparatus on the server side to generate a prompt sentence, according to a use situation of mobility assistance for a visually impaired user, for specifying an analysis target and an output format, and to supply the generative machine learning model with a multimodal input in which the prompt sentence is combined with the numerical data based on the image data,
to cause the generative machine learning model to extract features including signal indicators, passable regions, obstacles, and display information in the image data based on the prompt sentence, and to generate a natural language sentence as an analysis result relating to safety of walking,
to cause the analysis information processing apparatus on the server side to extract, from the natural language sentence, information elements indicating a signal state, a permission or prohibition of passage, and cautionary information, and to generate structured data including the information elements and to transmit the structured data back to the image acquisition device, and
to cause the image acquisition device to generate text for speech synthesis from the structured data, to control a sound signal generation device to generate audio data based on the text for speech synthesis, and to control an acoustic output device to output the audio data in real time.

### (Supplementary 2)

The system according to supplementary 1,
wherein the processor is configured to
cause the analysis information processing apparatus on the server side to describe the prompt sentence so as to limit objects in the image data, character information, and road surface states to items related to safe walking, to instruct the generative machine learning model to recognize the objects, the character information, and the road surface states and to determine a hazard level that they give to a traveling direction of a user, and to perform control to map a natural language sentence obtained from the generative machine learning model to the structured data.

### (Supplementary 3)

The system according to supplementary 1,
wherein the processor is configured to
cause the image acquisition device to determine content, length, and output frequency of the audio data based on the signal state and a safety evaluation included in the structured data, and to perform continuous notification from the acoustic output device while dynamically adjusting a volume and a speaking rate according to a movement speed of the user and an ambient sound level.

### Application Example 1

### (Supplementary 1)

A system comprising a processor,
wherein the processor is configured to
control an image capturing device connected to an information processing apparatus to continuously capture a surrounding environment and to generate moving image information, preprocess the moving image information by using predetermined image processing functionality and transmit the preprocessed moving image information to an information analysis apparatus,
generate an analysis instruction text including the moving image information and an analysis purpose corresponding to at least one of a user attribute and a usage situation, and input the analysis instruction text as a text-format prompt sentence to a generative information processing model,
generate, on a basis of analysis result information acquired from the generative information processing model, a concise description text indicating at least one of a potential hazardous event and a safe state,
control an audio information conversion apparatus to convert the description text into audio information and transmit the generated audio information to a portable information terminal via a communication path,
control the portable information terminal so as to present the audio information to a user in real time via an acoustic output device connected to the portable information terminal, and repeatedly execute, at a predetermined cycle, acquisition of the moving image information, generation of the analysis instruction text, analysis by the generative information processing model, and presentation of the audio information, thereby performing continuous monitoring of the surrounding environment and notification of danger.

### (Supplementary 2)

The system according to supplementary 1,
wherein the processor is configured to
cause the analysis instruction text to include content that instructs the generative information processing model to perform recognition of target elements and symbol information in the moving image information and semantic interpretation of the target elements and the symbol information, and, on a basis of the analysis result information, determine a relationship between at least one of the target elements and the symbol information and the potential hazardous event.

### (Supplementary 3)

The system according to supplementary 1,
wherein the processor is configured to
generate, as the description text, a guidance text including a recommended action corresponding to at least one of a role of the user and a behavioral situation of the user on a basis of the analysis result information, and cause the audio information conversion apparatus to convert the guidance text into audio output data in real time.

### Example 2

### (Supplementary 1)

A system comprising a processor,
wherein the processor is configured to
control an image acquisition device to capture surrounding environments of a user and to generate time-series image information,
transmit the image information to an information processing device via a communication device,
execute an image processing program on the information processing device to extract structured environment information regarding a walking route from the image information by using a machine learning model,
dynamically construct a prompt sentence to be input to a generative information processing model, based on the structured environment information and a movement state of the user, input the prompt sentence to the generative information processing model and cause the generative information processing model to generate a movement assistance instruction text corresponding to the structured environment information,
verify whether content of the movement assistance instruction text is consistent with the structured environment information and satisfies safety requirements, and modify or regenerate at least one of the prompt sentence and the movement assistance instruction text when the content does not satisfy the safety requirements, and
control a voice generation device to convert the verified movement assistance instruction text into acoustic information and provide the acoustic information to the user via an output device.

### (Supplementary 2)

The system according to supplementary 1,
wherein the processor is configured to
cause the machine learning model to perform object detection processing and region segmentation processing as image analysis processing, identify a passage region, an obstacle region, and a moving-object region, and generate the structured environment information including relative positional relationships and distance information of the regions.

### (Supplementary 3)

The system according to supplementary 1,
wherein the processor is configured to
construct the prompt sentence to include a scene description summarizing the structured environment information, user attributes, and instructions regarding length, expression style, and safety constraint conditions of the movement assistance instruction text, and to cause the generative information processing model to generate the movement assistance instruction text based on the prompt sentence.

### Application Example 2

### (Supplementary 1)

A system comprising a processor,
wherein the processor is configured to control an image acquisition device to continuously capture a surrounding environment and generate visual data,
transmit the visual data to an information processing device via a communication device, convert the visual data into a predetermined format, and store the converted visual data, execute an image processing program on the visual data to detect a plurality of targets and indicators and to generate structured data including target information,
dynamically generate a prompt sentence, based on the structured data and an operation mode, the prompt sentence instructing a generative learning model regarding an analysis content and an output format,
input the prompt sentence and the structured data into the generative learning model and obtain a natural language analysis result regarding a surrounding situation, generate guidance text data including a movement instruction or a warning, based on the analysis result and user attribute information, and determine a message type according to an importance level of the guidance text data,
control a speech synthesis device to convert the guidance text data into an audio signal and transmit the audio signal to an acoustic output device so that the audio signal is output to a user in real time,
acquire speech of the user, extract acoustic features from the speech, execute an emotion analysis model to estimate an emotional state of the user, and store the emotional state as session information, and
adjust at least one of a linguistic expression of the guidance text data and an audio output characteristic of the speech synthesis device according to the emotional state.

### (Supplementary 2)

The system according to supplementary 1,
wherein the processor is configured to
generate the prompt sentence by adding an environment description including at least a type of the targets, position information, risk information, and route information extracted from the structured data, and instruct the generative learning model, via the prompt sentence, to generate, based on the environment description, a movement instruction sentence or an explanatory sentence in a predetermined length and expression style.

### (Supplementary 3)

The system according to supplementary 1,
wherein the processor is configured to
obtain, as a neutral explanatory sentence, the analysis result, then generate a second prompt sentence including tone conditions corresponding to the emotional state and the message type, and input the second prompt sentence and the neutral explanatory sentence into the generative learning model so as to generate emotion-adapted guidance text data.

What is claimed is:

1. A system comprising:
circuitry configured to:
receive, via a communication interface coupled to a packet-switched network, image data acquired in a time series by an image acquisition device of a terminal device, and convert the image data into numerical data using preprocessing operations and normalize the numerical data into an input format compatible with a multimodal generative neural network model;
generate a prompt sentence specifying an analysis target and an output format based on an analysis context, and supply the multimodal generative neural network model with a multimodal input combining the prompt sentence and the normalized numerical data;
cause the multimodal generative neural network model to extract safety-related features from the image data including signal state indicators, passable region boundaries, obstacle locations, and display content, and generate a natural language sentence representing an analysis result; and
extract information elements from the natural language sentence indicating a signal state, a passage permission or prohibition determination, and cautionary object information, generate structured data comprising the extracted information elements, and transmit the structured data to the terminal device via the communication interface.

2. The system according to claim 1, wherein the circuitry is configured to perform the preprocessing operations by applying a noise reduction filter to each image frame in the image data, resampling the image frames to a target resolution, normalizing pixel intensity values to a standardized numerical range, and converting the processed image frames to a tensor representation suitable for the multimodal generative neural network model.

3. The system according to claim 2, wherein the circuitry is configured to process the time-series image data by applying a temporal differencing procedure to detect motion vectors between successive image frames, and incorporating the detected motion vectors as additional channels in the tensor representation to enable the multimodal generative neural network model to detect dynamic obstacles and moving objects.

4. The system according to claim 3, wherein the circuitry is configured to generate the prompt sentence by selecting prompt template components based on the analysis context, including a role instruction specifying safety-oriented feature extraction, an output format specification defining structured fields for signal state, passable regions, obstacles, and display content, and encoding the selected components as a token sequence.

5. The system according to claim 4, wherein the circuitry is configured to supply the multimodal generative neural network model with the multimodal input by interleaving image patch token embeddings computed from the normalized numerical data with text token embeddings of the prompt sentence in a combined input sequence, and processing the combined input sequence through cross-modal attention layers.

6. The system according to claim 1, wherein the circuitry is configured to extract the information elements from the natural language sentence by applying a named entity extraction procedure that identifies signal state tokens, directional instruction tokens, and obstacle category tokens, mapping the identified tokens to predefined semantic categories, and populating corresponding fields in the structured data.

7. The system according to claim 6, wherein the circuitry is configured to generate the structured data by encoding the extracted information elements as a structured record comprising a signal state field, a passage determination field with a binary permission value, a cautionary object list field, and a confidence score field derived from attention weight magnitudes in the multimodal generative neural network model output.

8. The system according to claim 7, wherein the circuitry is configured to apply a confidence threshold to the confidence score field of the structured data, and when the confidence score falls below the confidence threshold, generate a secondary prompt sentence requesting the multimodal generative neural network model to re-analyze a cropped region of interest from the image data.

9. The system according to claim 1, wherein the circuitry is configured to generate voice output data from the structured data by applying a text-to-speech synthesis procedure to a guidance sentence constructed from the information elements of the structured data, encode the voice output data in a voice codec format, and transmit the encoded voice output data to the terminal device via the communication interface for real-time playback through a voice output device.

10. The system according to claim 9, wherein the circuitry is configured to construct the guidance sentence by selecting a sentence template indexed by the passage determination field value, substituting the cautionary object list and signal state into the template to produce a natural language guidance string, and limiting the guidance string to a maximum token length to reduce synthesis latency.

11. The system according to claim 1, wherein the circuitry is configured to receive, via the communication interface, location information from the terminal device, retrieve map segment data from a storage device corresponding to the received location information, and incorporate the retrieved map segment data as supplementary context in the prompt sentence to enable the multimodal generative neural network model to generate analysis results conditioned on known spatial features of the surrounding area.

12. The system according to claim 11, wherein the circuitry is configured to compare extracted passable region boundaries with spatial boundary information in the retrieved map segment data, compute a spatial consistency score indicating agreement between extracted and map-derived boundaries, and include the spatial consistency score as a quality indicator in the structured data.

13. The system according to claim 1, wherein the circuitry is configured to store the structured data records in a storage device indexed by acquisition timestamp and terminal device identifier, and accumulate stored structured data records to compute a temporal obstacle frequency map indicating persistent obstacles detected across multiple image frames.

14. The system according to claim 13, wherein the circuitry is configured to detect a recurring obstacle condition from the temporal obstacle frequency map by identifying obstacles with detection frequency above a persistence threshold, generate an alert structured data record incorporating the recurring obstacle information, and transmit the alert structured data record to the terminal device via the communication interface.

15. The system according to claim 1, wherein the circuitry is configured to receive, from the terminal device via the communication interface, a categorical analysis request specifying a recognition objective, and generate an objective-specific prompt sentence by inserting the recognition objective into an objective specification field of the prompt template, enabling the multimodal generative neural network model to perform recognition tasks including object identification, character recognition, and semantic relationship extraction based on the specified objective.

16. The system according to claim 15, wherein the circuitry is configured to cache generated prompt sentences indexed by recognition objective in the storage device, retrieve a cached prompt sentence when a subsequent request specifies a matching recognition objective, and modify the cached prompt sentence by updating temporal context fields before supplying the multimodal input to the generative neural network model.

17. The system according to claim 1, wherein the circuitry is configured to monitor a transmission latency metric for the communication interface, and when the transmission latency metric exceeds a latency threshold, reduce the image resolution of image frames in the image data before conversion to numerical data to decrease processing time and transmission payload size.

18. A system comprising:
circuitry configured to:
receive, via a communication interface coupled to a packet-switched network, time-series image data from an image acquisition device of a terminal device, apply preprocessing operations including noise reduction, resolution resampling, intensity normalization, and temporal differencing to compute motion vectors, and normalize processed image frames into a tensor representation;
generate a prompt sentence comprising a role instruction, output format specification, and objective specification, and supply a multimodal generative neural network model with a multimodal input interleaving image patch token embeddings and text token embeddings through cross-modal attention layers;
cause the multimodal generative neural network model to extract safety-related features including signal state indicators, passable region boundaries, obstacle locations, and display content, and generate a natural language sentence representing an analysis result;
apply a named entity extraction procedure to the natural language sentence to identify signal state tokens, directional instruction tokens, and obstacle category tokens, populate a structured data record comprising a signal state field, a passage determination field, a cautionary object list field, and a confidence score field, and transmit the structured data to the terminal device via the communication interface; and
generate guidance voice output by constructing a guidance sentence from the information elements of the structured data using a sentence template indexed by the passage determination field value, applying text-to-speech synthesis to produce encoded voice output data, and transmitting the encoded voice output data to the terminal device.

19. The system according to claim 18, wherein the circuitry is configured to retrieve map segment data from a storage device based on location information received from the terminal device, compare extracted passable region boundaries with map-derived spatial boundaries to compute a spatial consistency score, and accumulate structured data records to generate a temporal obstacle frequency map identifying persistent obstacles.

20. A method comprising:
receiving, via a communication interface coupled to a packet-switched network, image data acquired in a time series by an image acquisition device of a terminal device, and converting the image data into numerical data using preprocessing operations and normalizing the numerical data into an input format compatible with a multimodal generative neural network model;
generating a prompt sentence specifying an analysis target and an output format based on an analysis context, and supplying the multimodal generative neural network model with a multimodal input combining the prompt sentence and the normalized numerical data;
causing the multimodal generative neural network model to extract safety-related features from the image data including signal state indicators, passable region boundaries, obstacle locations, and display content, and generate a natural language sentence representing an analysis result; and
extracting information elements from the natural language sentence indicating a signal state, a passage permission or prohibition determination, and cautionary object information, generating structured data comprising the extracted information elements, and transmitting the structured data to the terminal device via the communication interface.
